(19) United States
(12) Patent Application Publication
(10) Pub. No.: US 2019/0130175 A1
(43) Pub. Date: May 2, 2019

(54) OUTPUT CONTROL DEVICE, INTERCOM SLAVE UNIT, AND INTERCOM SYSTEM

(71) Applicant: SHARP KABUSHIKI KAISHA, Sakai City (JP)

(72) Inventors: KEN NAKASHIMA, Sakai City (JP); KATSUO DOI, Sakai City (JP)

(21) Appl. No.: 16/173,692

(22) Filed: Oct. 29, 2018

(30) Foreign Application Priority Data
Oct. 31, 2017 (JP) 2017-210974

(51) Int. Cl. G06K 9/00; H04M 3/527; H04M 7/12

(52) U.S. Cl. CPC G06K 9/00302; H04M 7/1225; H04M 3/527

(57) ABSTRACT

An embodiment of the present invention makes it possible to appropriately identify a visitor and respond in a manner considered appropriate by a resident. A server includes: a face recognition section configured to carry out face recognition of a visitor who has inputted a call operation, based on a captured image obtained from an intercom slave unit; and an output control section which carries out control so that output is carried out, in accordance with the result of the face recognition, by at least one of the shared call unit, an indoor monitor, and a mobile terminal.

This Nonprovisional application claims priority under 35 U.S.C. § 119 on Patent Application No. 2017-210974 filed in Japan on Oct. 31, 2017, the entire contents of which are hereby incorporated by reference.

### TECHNICAL FIELD

The present invention relates to, for example, an output control device which controls output in response to a call operation inputted into an intercom slave unit to call a resident, the intercom slave unit having a function of enabling a call to and a telephonic conversation with the resident.

### BACKGROUND ART

In conventionally known techniques, an intercom system includes (i) an intercom slave unit, installed to an outside of a residence, for making a call to and having a telephonic conversation with a resident and (ii) an intercom master unit, installed inside the residence, for answering the call.

Among such conventional intercom systems, some intercom systems are configured such that the intercom slave unit includes a camera and the intercom master unit includes a monitor, so that the resident can see the visitor, as in the techniques disclosed in Patent Literature 1 below.

### CITATION LIST

### Patent Literature

[Patent Literature 1] Japanese Patent Application Publication Tokukai No. 2002-16710 (Publication date: Jan. 18, 2002)

### SUMMARY OF INVENTION

### Technical Problem

In the above-described conventional techniques, the resident checks and determines who the visitor is. As such, in a case where the resident has incorrectly determined who the visitor is, the resident may not be able to respond in a manner that the resident considers appropriate. For example, in a case where the visitor is solicitor or other such person whom the resident normally would not wish to respond to, there is the risk that the resident will mistakenly commence a conversation with the visitor due to an error in determining who the visitor is.

An aspect of the present invention has been made in view of the above problem. An object of an aspect of the present invention is to provide an output control device which makes it possible to appropriately identify a visitor and respond in a manner considered appropriate by a resident.

### Solution to Problem

In order to solve the above problem, an output control device in accordance with an aspect of the present invention is an output control device which controls output relating to a call, the call being made in accordance with a call operation inputted by a visitor into an intercom slave unit having a function of enabling a call to and a telephonic conversation with a resident, the output control device including: a face recognition section configured to carry out face recognition of the visitor based on a captured image obtained from the intercom slave unit; and an output control section which carries out control so that the output is carried out, in accordance with a result of the face recognition carried out by the face recognition section, by at least one of (i) the intercom slave unit, (ii) an intercom master unit having an answer function of enabling answering the call and carrying out a telephonic conversation with the visitor, and (iii) a telephonic conversation device which differs from the intercom master unit but has the answer function.

In order to solve the above problem, an intercom system in accordance with an aspect of the present invention is an intercom system including: an intercom slave unit having a function of enabling a call to and a telephonic conversation with a resident; an intercom master unit having an answer function of enabling (i) answering a call from the intercom slave unit and (ii) carrying out a telephonic conversation between the intercom master unit and the intercom slave unit; and an output control device which controls output carried out in response to a call operation inputted by a visitor into the intercom slave unit, the intercom system being configured to carry out face recognition of the visitor who inputted the call operation, based on a captured image obtained from the intercom slave unit, the intercom system being configured to carry out control so that the output is carried out, in accordance with a result of the face recognition, by at least one of (i) the intercom slave unit, (ii) the intercom master unit, and (iii) a telephonic conversation device which differs from the intercom master unit but has the answer function.

### Advantageous Effects of Invention

An embodiment of the present invention brings about the advantageous effect of making it possible to appropriately identify a visitor and respond in a manner considered appropriate by a resident.

### BRIEF DESCRIPTION OF DRAWINGS

FIG. 1 is a block diagram illustrating an example configuration of main parts of devices included in an intercom system in accordance with Embodiments 1 and 2 of the present invention.

FIG. 2 is a diagram illustrating an example of how the shared call unit illustrated in FIG. 1 operates.

FIG. 3 is a diagram illustrating an example of how the indoor monitor illustrated in FIG. 1 operates.

FIG. 4 is a diagram illustrating a specific example of a face image database stored on the server illustrated in FIG. 1.

FIG. 5 is a diagram illustrating variations of an automatic answer which the shared call unit carries out in accordance with control by the server illustrated in FIG. 1.

FIG. 6 is a flowchart illustrating an example flow of answer processing carried out by the shared call unit illustrated in FIG. 1.

FIG. 7 is a flowchart illustrating an example flow of processing for determining the content of an answer, as carried out by the server illustrated in FIG. 1.

FIG. 8 is a diagram illustrating an example of an automatic answer in accordance with a variation of Embodiment 1.

FIG. 9 is a diagram illustrating examples of how the indoor monitor illustrated in FIG. 1 operates in accordance with Embodiment 2.

FIG. 10 is a diagram illustrating another example of how the indoor monitor illustrated in FIG. 1 operates in accordance with Embodiment 2.

FIG. 11 is a diagram illustrating an example of how the shared call unit operates in a case where face recognition has failed.

FIG. 12 is a flowchart illustrating an example flow of processing for determining the content of a call action, as carried out by the server illustrated in FIG. 1.

FIG. 13 is a flowchart illustrating an example flow of call processing carried out by the indoor monitor illustrated in FIG. 1.

FIG. 14 is a flowchart illustrating an example flow of answer processing carried out by the shared call unit illustrated in FIG. 1 in accordance with Embodiment 2.

FIG. 15 is a block diagram illustrating an example configuration of main parts of devices included in an intercom system in accordance with Embodiments 3 and 4 of the present invention.

FIG. 16 is a diagram schematically illustrating the intercom system illustrated in FIG. 15.

FIG. 17 is a diagram illustrating a specific example of a face image database stored on the server illustrated in FIG. 15.

FIG. 18 is a diagram illustrating (i) examples of a message board screen to be displayed on the mobile terminal illustrated in FIG. 15 and (ii) an example of a transition from the message board screen.

FIG. 19 is a diagram illustrating example screens, relating to a post notification, as displayed by the mobile terminal illustrated in FIG. 15.

FIG. 20 is a diagram illustrating how a resident can be added to a telephonic conversation with a visitor.

FIG. 21 is a flowchart illustrating an example flow of notification processing carried out by the server illustrated in FIG. 15.

FIG. 22 is a diagram illustrating an example of an edit area used for editing a piece of visitor information, which edit area is displayed by the mobile terminal illustrated in FIG. 15.

FIG. 23 is a diagram illustrating examples of a message board screen displayed on the mobile terminal illustrated in FIG. 15, in accordance with Embodiment 4.

FIG. 24 is a diagram illustrating an example of how a visitor can be informed of a planned time of return.

FIG. 25 is a diagram illustrating variations of the visit notification message to be displayed after a response is finished.

FIG. 26 is a flowchart illustrating an example flow of notification processing carried out by the server illustrated in FIG. 15, in accordance with Embodiment 4.

FIG. 27 is a block diagram illustrating a configuration of a computer by which a server, a shared call unit, an indoor monitor, and a mobile terminal can be realized.

### DESCRIPTION OF EMBODIMENTS

### Embodiment 1

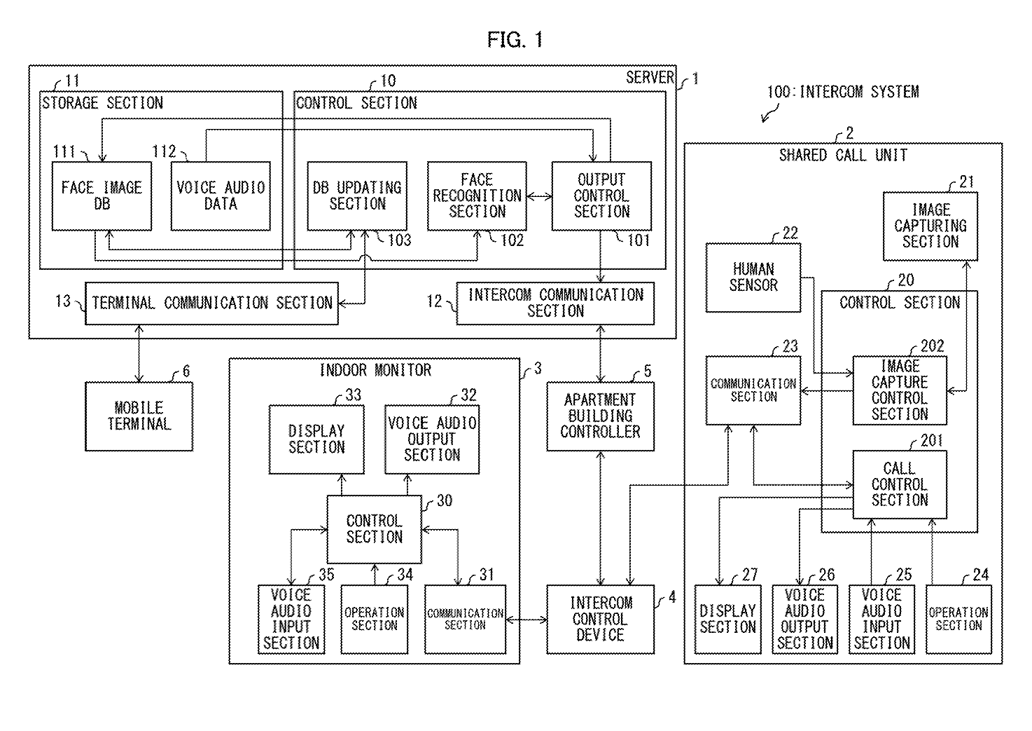

The following description will discuss Embodiment 1 of the present invention, with reference to FIGS. 1 to 8. FIG. 1 is a block diagram illustrating an example configuration of main parts of devices included in an intercom system 100 in accordance with the present embodiment. As illustrated in FIG. 1, the intercom system 100 includes a server 1 (output control device), a shared call unit 2 (intercom slave unit), an indoor monitor 3 (intercom master unit), an intercom control device 4, an apartment building controller 5, and a mobile terminal 6.

(Shared Call Unit 2)

The shared call unit 2 is a device for calling residents of each residence. In the present embodiment, descriptions of the shared call unit 2 assume an example where the shared call unit 2 is installed at an entrance of an apartment building, near a door (front door) at the entrance. Note, however, that the present invention is not limited to such a configuration. As illustrated in FIG. 1, the shared call unit 2 includes a control section 20, an image capturing section 21, a human sensor 22 (human sensing section), a communication section 23, an operation section 24, a voice audio input section 25, a voice audio output section 26, and a display section 27.

The human sensor 22 detects a person present in the vicinity of the shared call unit 2. Examples of the human sensor 22 include, but are not limited to, an infrared sensor. The image capturing section 21 is a so-called camera that captures an image of a visitor who operates the shared call unit 2 and attempts to call a resident. In the present embodiment, the image capturing section 21 commences capturing an image in a case where the human sensor 22 detects a person (that is, a visitor). The image capturing section 21 carries out image capturing in a manner so that a captured image includes the entirety of the visitor's face. For example, the image capturing section 21 is provided at a position at which it is possible to capture an image including the entirety of the visitor's face. Herein, descriptions of the image capturing section 21 assume an example where the image capturing section 21 captures moving images, but the image capturing section 21 may capture still images. The communication section 23 communicates with another device(s). In the present embodiment, the communication section 23 communicates with the intercom control device 4 so as to transmit and receive information, via the intercom control device 4, to and from devices included in the intercom system 100.

The operation section 24 accepts an operation (a call operation), carried out by the visitor, to call the resident. Examples of the operation section 24 include, but are not limited to, one or more buttons (keys) which can be pressed by a user. The voice audio input section 25 is a so-called microphone that obtains voice audio spoken by the visitor. The voice audio output section 26 is a so-called speaker that outputs, as voice audio, voice audio data received by the shared call unit 2 from another device. Examples of the voice audio data to be received from another device include, but are not limited to, voice audio data of voice audio which is spoken by the resident and inputted into the indoor monitor 3. The display section 27 displays an image in accordance with various information obtained by the shared call unit 2.

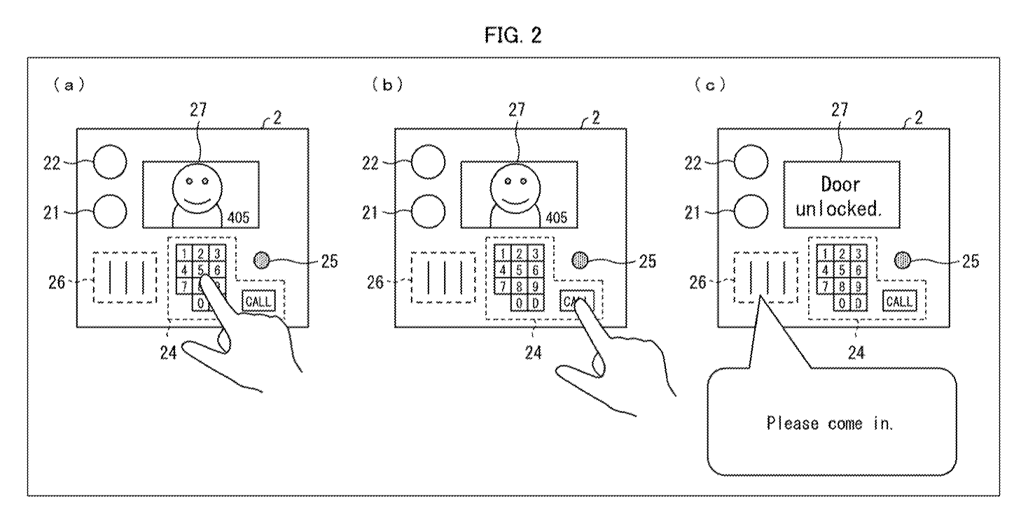

FIG. 2 is a diagram illustrating an example of how the shared call unit 2 operates. As described above, a visitor who stands in front of the shared call unit 2 is detected by the human sensor 22. Once the visitor is detected, the image capturing section 21 commences capturing an image of the visitor. As illustrated in (a) of FIG. 2, a captured image is displayed by the display section 27. Then, as illustrated in (a) of FIG. 2, the visitor carries out an operation on the operation section 24 to input an apartment number of an apartment which the visitor intends to visit. Specifically, the apartment number is inputted by the visitor pressing keys of a numeric keypad. In a case where the visitor inputs an incorrect number, the incorrect number can be deleted by pressing a delete key (a key having the letter “D” thereon). The display section 27 may display the apartment number inputted by the visitor, as illustrated in (a) of FIG. 2.

Once the visitor finishes inputting the number of the apartment to be visited, the visitor presses a call key (a key having the word “Call” thereon), as illustrated in (b) of FIG. 2. After the visitor presses the call key, a call action to be carried out by the indoor monitor 3, which is installed in an apartment having the inputted apartment number (in the illustrated example, apartment number 405). A typical example of the call action is the indoor monitor 3 outputting a ringing tone.

After the call action, in a case where the indoor monitor 3 accepts an unlock operation by the resident, the front door is unlocked, and the visitor can then enter the apartment building. In a case where the resident inputs voice audio into the indoor monitor 3 (in the illustrated example, the phrase “Come in,” spoken by the resident), the voice audio is outputted from voice audio output section 26, as illustrated in (c) of FIG. 2. As illustrated in (c) of FIG. 2, the display section 27 may display a notification (in the illustrated example, text reading “Unlocked”) indicating that the front door has been unlocked. The notification may be outputted from the voice audio output section 26 as voice audio (for example, voice audio saying “The door will be unlocked”).

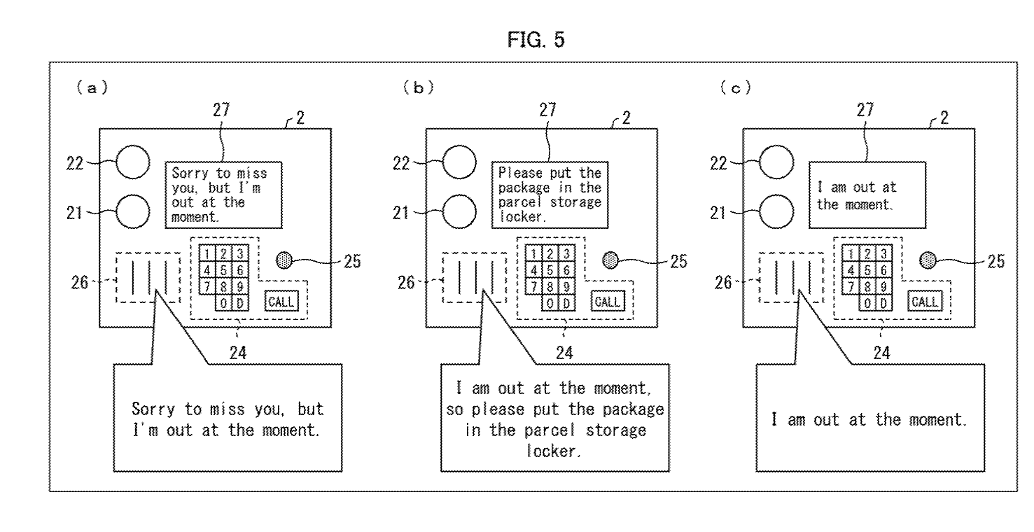

Note that in the drawings, text in speech balloons represents voice audio outputted by the shared call unit 2 or the indoor monitor 3. Text in a speech balloon with rounded corners, such as that shown in FIG. 2, indicates that the voice audio being outputted by the shared call unit 2 or the indoor monitor 3 is voice audio that has been spoken by a resident or visitor. Text in a speech balloon with non-rounded corners, such as that shown in FIG. 5 (described later), indicates that the voice audio being outputted by the shared call unit 2 or indoor monitor 3 is voice audio which is outputted as a result of control by the server 1 (that is, automated voice audio).

The control section 20 comprehensively controls functions of the shared call unit 2. The control section 20 includes a call control section 201 and an image capture control section 202 (transmitting section).

The image capture control section 202 controls the image capturing section 21. Specifically, the image capture control section 202 controls the image capturing section 21 so that the image capturing section 21 commences capturing an image in a case where the image capture control section 202 obtains, from the human sensor 22, a detection signal indicating that a person has been detected. The image capture control section 202 also supplies a captured image to the call control section 201 and controls the communication section 23 so that the communication section 23 transmits the captured image to the indoor monitor 3 and to the server 1. The captured image is transmitted to the indoor monitor 3 via the intercom control device 4. The captured image is transmitted to the server 1 via the intercom control device 4 and the apartment building controller 5

The call control section 201 controls a call to the resident and an answer to the visitor. Specifically, in a case where the call control section 201 obtains a call signal from the operation section 24, the call control section 201 controls the communication section 23 so that the communication section 23 transmits the call signal to the indoor monitor 3 and to the server 1. The call signal is a signal that indicates that the call key was pressed. The call signal includes the apartment number which was inputted.

In a case where the call control section 201 obtains voice audio data from the communication section 23, the call control section 201 controls the voice audio output section 26 so that the voice audio output section 26 uses the voice audio data to output voice audio. The voice audio data is transmitted from the indoor monitor 3 or the server 1. Voice audio data which is transmitted from the indoor monitor 3 is voice audio that has been inputted into the indoor monitor 3 by the resident as described above. Such voice audio data is transmitted to the shared call unit 2 via the intercom control device 4. Voice audio data which is transmitted from the server 1 is described later.

The call control section 201 also controls displaying of an image by the display section 27. For example, the call control section 201 controls the display section 27 so that the display section 27 displays a captured image obtained from the image capture control section 202. In a case where the call control section 201 obtains, from the operation section 24, a signal indicating that a key of the numeric keypad has been pressed, the call control section 201 controls the display section 27 so that the display section 27 displays a number corresponding to the signal. In a case where the front door has been unlocked, the call control section 201 controls the display section 27 so that the display section 27 displays a notification indicating that the door has been unlocked.

The call control section 201 also controls the communication section 23 so that the communication section 23 transmits, to the indoor monitor 3, voice audio data of voice audio obtained by the voice audio input section 25. In this way, the indoor monitor 3 is controlled so as to output the voice audio spoken by the visitor.

(Indoor Monitor 3)

The indoor monitor 3 is a monitor which is provided inside a residence. The indoor monitor 3 has an answer function of enabling answering a call from the shared call unit and carrying out a telephonic conversation. As illustrated in FIG. 1, the indoor monitor 3 includes a control section 30, a communication section 31, a voice audio output section 32, a display section 33, an operation section 34, and a voice audio input section 35.

The control section 30 comprehensively controls functions of the indoor monitor 3. The communication section 31 communicates with another device(s). In the present embodiment, the communication section 31 communicates with the intercom control device 4 so as to transmit and receive information, via the intercom control device 4, to and from the shared call unit 2. The voice audio output section 32 is a so-called speaker that outputs, as voice audio, voice audio data received by the indoor monitor 3 from the shared call unit 2. In other words, the voice audio output section 32 outputs voice audio spoken by the visitor, in accordance with voice audio data inputted into the shared call unit 2. The display section 33 displays an image in accordance with various information obtained by the indoor monitor 3. Specifically, the display section 33 displays a captured image transmitted from the shared call unit 2. The operation section 34 accepts an operation by, for example, the resident. Described in the present embodiment is an example in which the operation section 34 is a touch panel provided integrally with the display section 33. In other words, in addition to displaying the captured image, the display section 33 also displays a user interface (UI) for accepting an operation by the resident. Note that the operation section 34 is not limited to being a touch panel. For example, the operation section 34 may be one or more physical buttons (keys) which are provided separately from the display section 33. The voice audio input section 35 is a so-called microphone that obtains voice audio spoken by the resident.

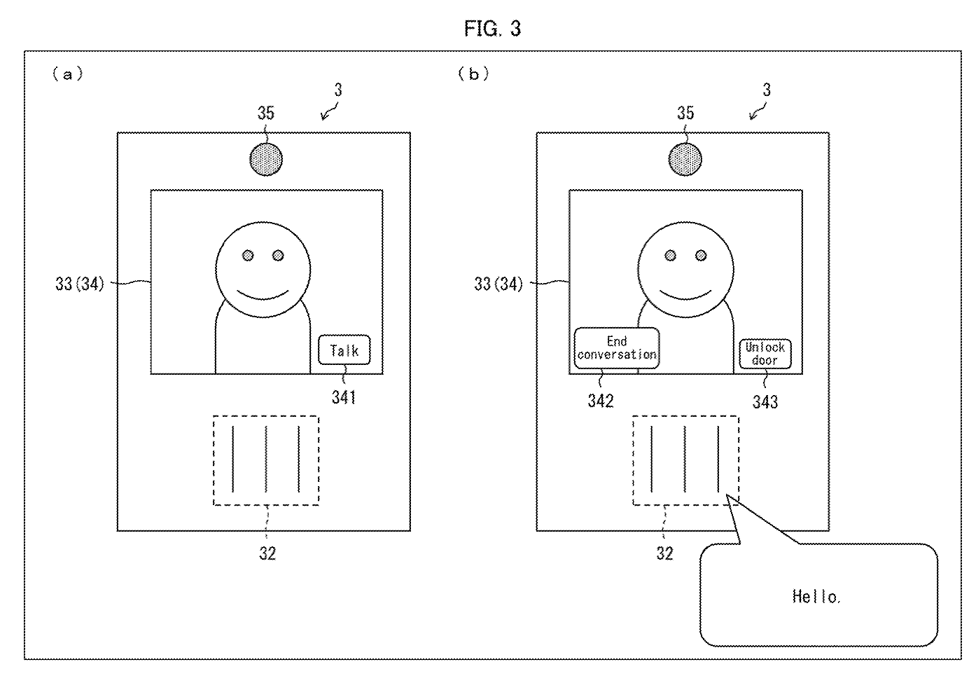

FIG. 3 is a diagram illustrating an example of how the indoor monitor 3 operates. In a case where the control section 30 receives, via the communication section 31, a call signal transmitted from the shared call unit 2, the control section 30 controls the voice audio output section 32 so that the voice audio output section 32 outputs a ringing tone. As illustrated in FIG. 3, the control section 30 also controls the display section 33 so that the display section 33 displays a captured image transmitted from the shared call unit 2. The control section 30 also controls the display section 33 so that display section 33 displays a UI 341, as illustrated in (a) of FIG. 3. The UI 341 is for accepting an operation to commence a telephonic conversation with the visitor. In a case where the resident touches the UI 341, the control section 30 turns on the voice audio output section 32 and the voice audio input section 35 and controls the voice audio output section 32 and the voice audio input section 35 so as to await (i) reception of voice audio data representing voice audio inputted by the visitor and (ii) voice audio input (speech) from the resident. In a case where the control section 30 receives the voice audio data transmitted from the shared call unit 2, the control section 30 controls the voice audio output section 32 so that the voice audio output section 32 uses the voice audio data to output voice audio (see (b) of FIG. 3). The control section 30 also controls the communication section 31 so that the communication section 31 transmits, to the shared call unit 2, voice audio data representing the voice audio obtained by the voice audio input section 35. In this way the shared call unit 2 is controlled so as to output voice audio spoken by the resident.

Furthermore, in a case where the resident touches the UI 341, the control section 30 controls the display section 33 so that (i) the display section 33 ceases displaying the UI 341 and (ii) the display section 33 displays a UI 342 and a UI 343, as illustrated in (b) of FIG. 3. The UI 342 is for accepting an operation to end the telephonic conversation with the visitor. In a case where the resident touches the UI 342, the control section 30 turns off the voice audio output section 32 and the voice audio input section 35. The UI 343 is for accepting an operation to unlock the front door. In a case where the resident touches the UI 343, the control section 30 supplies, via the communication section 31 and to the intercom control device 4, an unlock signal for unlocking the front door. The unlock signal is transmitted from the intercom control device 4 to an electric lock (not illustrated) provided in the front door. This unlocks the front door.

(Intercom Control Device 4)

The intercom control device 4 controls transmission and reception of information between the shared call unit 2 and the indoor monitor 3 in each residence. In a case where the intercom control device 4 receives the call signal from the shared call unit 2, the intercom control device 4 refers to an apartment number included in the call signal, identifies the indoor monitor 3 to which the call signal is to be transmitted, and transmits the call signal to the indoor monitor 3 thus identified. The intercom control device 4 also transmits the received call signal to the server 1.

In a case where the intercom control device 4 receives the captured image from the shared call unit 2, the intercom control device 4 transmits the captured image to the server 1. In other words, in the present embodiment, the captured image is transmitted to the server 1 before the call signal is. Because it is necessary to identify the indoor monitor 3 to which the captured image is to be transmitted, the captured image is transmitted to the indoor monitor 3 once the intercom control device 4 has received the call signal.

The intercom control device 4 also transmits, to the shared call unit 2, voice audio data received from the indoor monitor 3 and the server 1. The intercom control device 4 also transmits, to the indoor monitor 3, voice audio data received from the shared call unit 2.

(Apartment Building Controller 5)

The apartment building controller 5 connects the server 1 and the intercom control device 4 in a manner so as enable communication between the server 1 and the intercom control device 4. In other words, the apartment building controller 5 connects the server 1 and the shared call unit 2 installed in the apartment building in a manner so as to enable communication between the server 1 and the shared call unit 2. The apartment building controller 5 transmits, to the server 1, the call signal received from the intercom control device 4 and the captured image received from the intercom control device 4. When the apartment building controller 5 transmits the call signal to the server 1, the apartment building controller 5 converts the apartment number included in the call signal into information (a monitor ID) that enables unique identification of the indoor monitor 3 which will receive the call, from among indoor monitors 3 in a plurality of residences. The monitor ID in accordance with the present embodiment includes (i) an apartment building controller ID that enables the server 1 to uniquely identify the apartment building controller 5 and (ii) the apartment number. The apartment building controller ID is generated in advance by the server 1 and transmitted to the apartment building controller 5, so that the apartment building controller ID is stored in advance by the apartment building controller 5. This makes it possible for the server 1 to identify (i) to which apartment building the shared call unit 2 making a call belongs, and (ii) for which indoor monitor 3 the call signal is intended, even in a case where the server 1 manages intercom systems 100 in a plurality of apartment buildings. Note that in a case where the server 1 manages an intercom system 100 in only one apartment building, the conversion of the apartment number into a monitor ID may be omitted. The apartment building controller 5 also transmits, via the intercom control device 4 and to the shared call unit 2, voice audio data received from the server 1.

(Server 1)

The server 1 controls output which is carried out in response to the call operation inputted into the shared call unit 2. Specifically, in a case where there is no answer from the resident in response to the call operation, the server 1 controls the shared call unit 2 so that the shared call unit 2 carries out an automatic answer. As illustrated in FIG. 1, the server 1 includes a control section 10, a storage section 11, an intercom communication section 12, and a terminal communication section 13.

The intercom communication section 12 communicates with the shared call unit 2 via the apartment building controller 5 and the intercom control device 4. The terminal communication section 13 communicates with the mobile terminal 6.

The storage section 11 stores various types of data used by the server 1. The storage section 11 stores at least a face image database (face image DB) 111 and voice audio data 112. The voice audio data 112 is a plurality of pieces of voice audio data which can be used for an automatic answer.

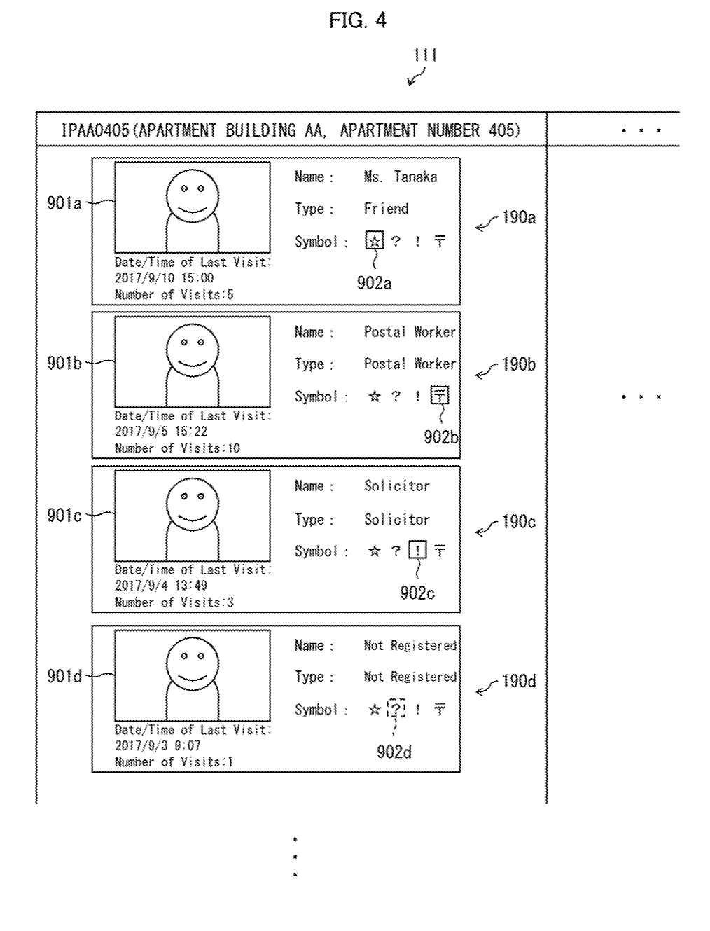

The face image DB 111 is a database (DB) for managing information about visitors (visitor information). The information includes face images of visitors. FIG. 4 is a diagram illustrating one specific example of the face image DB 111. Note that a data structure and data content of the face image DB 111 are not limited to the example illustrated in FIG. 4. As illustrated in FIG. 4, the face image DB 111 is for managing visitor information on a per-monitor-ID basis. In other words, the face image DB 111 is for managing, on a per-residence basis, information regarding visitors who have visited each residence. In the example of FIG. 4, visitor information 190a through 190d is stored in a column for the monitor ID “IPAA0405”. In this monitor ID, “AA” corresponds to the apartment building controller ID, and “0405” corresponds to the apartment number. Note that in the descriptions below, in cases where it is not necessary to distinguish between the visitor information 190a through 190d, the visitor information 190a through 190d is collectively referred to as visitor information 190.

As illustrated in FIG. 4, the visitor information 190 is information about visitors who have visited apartment number 405 in apartment building AA. The visitor information 190 includes face images 901 of visitors, names of the visitors, types (categories) of the visitors, symbols 902 which indicate the types, dates/times of last visit, number of visits, and data (facial characteristic data) that (i) indicates facial characteristics of faces and (ii) is included in the face images 901. The “face images 901 of visitors” collectively refers to face images 901a to 901d illustrated in FIG. 4. The “symbols 902 which indicate the types” collectively refers to symbols 902a through 902c illustrated in FIG. 4. The face images 901 may be, for example, still images which the control section 10 has taken from a captured video image. Note that in the descriptions below, the term “setting information” may be used to collectively refer to the name of a visitor, the type of the visitor, and the symbol 902 indicating the type. Note also that although the facial characteristic data is described here as being included in the face images 901, the facial characteristic data is not illustrated in FIG. 4. The facial characteristic data may be included in the visitor information 190 separately from the face images 901. Further note that although FIG. 4 illustrates an example in which the visitor information 190 is ordered in the column “IPAA0405” by the most recent date/time of last visit, this example is non-limiting.

Visitor information 190a is visitor information for “Ms. Tanaka,” who is a friend of the resident living in apartment number 405 of apartment building AA. The visitor information 190a includes the face image 901a of Ms. Tanaka. Out of the symbols 902, the symbol 902a, which indicates a friend or acquaintance, has been selected in the visitor information 190a. The visitor information 190b is visitor information for a postal worker. The visitor information 190b includes the face image 901b of the postal worker. Out of the symbols 902, the symbol 902b, which indicates a postal worker or a parcel delivery worker, has been selected for the visitor information 190b. The visitor information 190c is visitor information for a salesperson. The visitor information 190c includes the face image 901c of the salesperson. Out of the symbols 902, the symbol 902c, which indicates a person requiring caution, has been selected for the visitor information 190c. The visitor information 190d is visitor information for a person for whom the various information has not yet been set. The visitor information 190d includes the face image 901d of a visitor who has visited (or who has attempted/is attempting to visit) apartment number 405 of apartment building AA, but the name, type, etc. of the visitor are displayed as “Not Registered”. The symbol 902d indicates that it is unknown what sort of person the visitor is. The symbol 902d may be a symbol which is automatically selected in a case where the name, type, etc. of the visitor are not registered, as is the case with visitor information 190d.

The control section 10 comprehensively controls the functions of the server 1. The control section 10 includes an output control section 101, a face recognition section 102, and a database updating section (DB updating section) 103.

The output control section 101 controls automatic answering carried out by the shared call unit 2. Specifically, in a case where the output control section 101 obtains, from the intercom communication section 12, a captured image transmitted from the shared call unit 2, the output control section 101 supplies the captured image to the face recognition section 102 and controls the face recognition section 102 so that the face recognition section 102 carries out face recognition. Thereafter, the output control section 101 obtains a result of the face recognition from the face recognition section 102.

In a case where the output control section 101 receives, from the apartment building controller 5 and via the intercom communication section 12, a call signal including a monitor ID, the output control section 101 supplies the call signal to the face recognition section 102.

The face recognition section 102 carries out recognition of a visitor's face based on a captured image. Specifically, in a case where the face recognition section 102 obtains a captured image from the output control section 101, the face recognition section 102 extracts characteristics of the face of the visitor from the captured image. Next, in a case where the face recognition section 102 obtains a call signal from the output control section 101, the face recognition section 102 identifies, from a column in the face image DB 111 corresponding to the monitor ID contained in the call signal, a piece of the visitor information 190 which contains a face image 901 matching the extracted facial characteristics. Specifically, the face recognition section 102 compares the extracted facial characteristics to facial characteristic data contained in each piece of the visitor information 190, and identifies a piece of the visitor information 190 for which a match rate is equal to or greater than a predetermined value. In this way, by extracting facial characteristics of a visitor before a call signal is obtained, it is possible decrease an amount of time taken from when the visitor carries out a call operation to when the piece of the visitor information 190 is identified. The face recognition section 102 then reads out the piece of the visitor information 190 thus identified and supplies the piece of the visitor information 190, as a recognition result, to the output control section 101.

In a case where the face recognition section 102 does not successfully identify a piece of the visitor information 190 containing a face image 901 which matches the facial characteristics (i.e., in a case where the visitor in the captured image is visiting the resident for the first time), the face recognition section 102 supplies, to the output control section 101, a recognition result which provides notification of such.

The following description further describes the output control section 101. In a case where the output control section 101 obtains a piece of the visitor information 190 from the face recognition section 102, the output control section 101 identifies a type or a symbol of the visitor, which type or signal is included in that piece of the visitor information 190. The output control section 101 then identifies, from among the voice audio data 112, a piece of voice audio data in accordance with the identified type or symbol, and reads out the voice audio data thus identified. In a case where the output control section 101 receives, from the face recognition section 102, a notification indicating that a piece of the visitor information 190 could not be identified, the output control section 101 identifies, from among the voice audio data 112, a piece of voice audio data for use in case where a piece of the visitor information 190 cannot be identified (that is, predetermined voice audio data), and reads out the piece of voice audio data thus identified.

The output control section 101 then transmits the piece of voice audio data thus identified, via the intercom communication section 12, to the apartment building controller 5 of an apartment building identified from the monitor ID (for example, an apartment building whose apartment building controller ID is “AA”). The piece of voice audio data is then transmitted to the shared call unit 2 of the apartment building thus identified, and an automatic answer is carried out.

FIG. 5 is a diagram illustrating variations of the automatic answer. For example, in a case where the face recognition section 102 has read out the visitor information 190a, the output control section 101 controls the shared call unit 2 so that the shared call unit 2 to carries out the automatic answer illustrated in (a) of FIG. 5. In this example, for voice audio data to be used in an automatic answer to a visitor that is an acquaintance or friend, the output control section 101 uses voice audio data for voice audio which conveys a sense of friendliness. In the illustrated example, this voice audio data is for the phrase, “Sorry to miss you, but I'm out at the moment.” In a case where the face recognition section 102 has read out the visitor information 190b, the output control section 101 controls the shared call unit 2 so that the shared call unit 2 carries out, for example, the automatic answer illustrated in (b) of FIG. 5. In this example, for voice audio data to be used in an automatic answer to a visitor that is a postal worker or parcel delivery worker, the output control section 101 uses voice audio data representing voice audio which prompts the visitor to put a parcel in a parcel storage locker. In the illustrated example, this voice audio is for the phrase, “I am out at the moment, so please put the package in the parcel storage locker.” This makes it possible to avoid the need for the parcel to be redelivered. In a case where the face recognition section 102 is unable to identify a piece of the visitor information 190, the output control section 101 controls the shared call unit 2 so that the shared call unit 2 carries out, for example, the automatic answer illustrated in (c) of FIG. 5. In this example, for voice audio data to be used in an automatic answer in a case where the visitor cannot be identified, the output control section 101 uses voice audio data representing voice audio which can be used regardless of who the visitor is. In the illustrated example, this voice audio data is for the phrase, “I am not home right now.” Note that the variations of the automatic answer illustrated in FIG. 5 are examples which do not serve to limit the content of an automatic answer to that shown in FIG. 5.

The output control section 101 may control the display section 27 so that the display section 27 displays the content of the answer along with the voice audio output, as illustrated in FIG. 5. In such a case, displaying the content of the answer may be achieved by the output control section 101 converting the voice audio data into text and then transmitting the text to the shared call unit 2. Alternatively, displaying the content of the answer may be achieved by the output control section 101 reading out, together with the voice audio data, text (not illustrated in FIG. 1) that corresponds to the voice audio data stored in the storage section 11, and transmitting the text to the shared call unit 2.

In the present embodiment, the output control section 101 controls the shared call unit 2 to that the shared call unit 2 carries out an automatic answer in a case where (i) a predetermined amount of time has elapsed since a call operation was inputted into the shared call unit 2 and (ii) during the predetermined amount of time, no answer was carried out with use of the indoor monitor 3. Specifically, in a case where the call control section 201 of the shared call unit 2 has transmitted a call signal to the server 1 and to the indoor monitor 3, the call control section 201 measures an elapsed amount of time starting from when the call signal was transmitted. In a case where the elapsed amount of time exceeds a predetermined threshold, the call control section 201 transmits, to the server 1, a request for data for an automatic answer (hereinafter, “automatic-answer-data request”). Once the output control section 101 receives the automatic-answer-data request, the output control section 101 transmits an identified piece of voice audio data to the shared call unit 2. Note that examples of an answer carried out with use of the indoor monitor 3 include (i) voice audio being inputted by the resident into the indoor monitor 3 and (ii) the front door being unlocked by an operation inputted into the indoor monitor 3 by the resident.

In a case where the output control section 101 obtains a piece of the visitor information 190 from the face recognition section 102, the output control section 101 updates the date/time of last visit recorded in the piece of visitor information so as to reflect the date/time the call signal was received, increases the number of visits recorded in the piece of visitor information by one, and then stores this updated information in the face image DB 111. In other words, the output control section 101 updates the date/time of last visit and the number of visits recorded in the piece of the visitor information 190 identified by the face recognition section 102.

In a case where the output control section 101 receives, from the face recognition section 102, a notification indicating that a piece of the visitor information 190 could not be identified, the output control section 101 generates a new piece of visitor information 190 in accordance with the captured image. Specifically, the output control section 101 generates a piece of visitor information 190 by (i) generating a face image 901 by taking a still image from the captured image and (ii) associating a date/time of last visit and a number of visits with the face image 901. The date/time at which the call signal was received may be used as the date/time of last visit. The number of visits may be set to be “1”. In this way, a piece of visitor information 190 is generated in which the visitor's name, type, etc. are not registered, as with the visitor information 190d illustrated in FIG. 4. The output control section 101 stores this newly generated piece of visitor information 190 in an appropriate column of the face image DB 111.

The DB updating section 103 updates the visitor information 190 in accordance with an instruction to update the visitor information 190, which instruction is transmitted from the mobile terminal 6. An update to the visitor information 190 carried out with use of the mobile terminal 6 can be, for example, setting the name, type, etc. of the visitor in the visitor information 190d illustrated in FIG. 4.

The mobile terminal 6 accepts an operation inputted by the resident and then transmits a user ID (that is, information that identifies the resident) to the server 1. For example, the mobile terminal 6 starts up an application in accordance with an operation by the resident, accepts a user ID and a password for logging in, and transmits the user ID to the server 1.

Upon receiving the user ID, the DB updating section 103 refers to a database (not illustrated in FIG. 1) in which user IDs are associated with monitor IDs and identifies a monitor ID. The DB updating section 103 then reads out, from the face image DB 111, the visitor information 190 contained in the column for the monitor ID thus identified and transmits the visitor information 190 to the mobile terminal 6.

The mobile terminal 6 displays the visitor information 190 thus received. Then, in a case where the mobile terminal 6 accepts, from the resident, an operation to select a piece of the visitor information 190, the mobile terminal 6 displays a screen (setting screen) for setting various information in the piece of visitor information 190 thus selected. The mobile terminal 6 accepts a setting operation from the resident. The setting operation is, for example, an operation for inputting a name of the visitor, selecting a type and symbol of the visitor, changing the face image 901 of the visitor, etc. Then, upon accepting a predetermined operation, the mobile terminal 6 transmits, to the server 1, the piece of the visitor information 190 that has been modified. The DB updating section 103 updates the visitor information 190 by storing, in the face image DB 111, the piece of visitor information 190 which has been received. Details of the setting screen are described later in Embodiment 3.

Described above is an example in which the resident updates the visitor information 190 by operating the mobile terminal 6. Note, however, that the visitor information 190 may be updated by the resident operating the indoor monitor 3. For example, the above-described application may be installed in the indoor monitor 3, or the indoor monitor 3 may have a function equivalent to the application.

(Flow of Answer Processing)

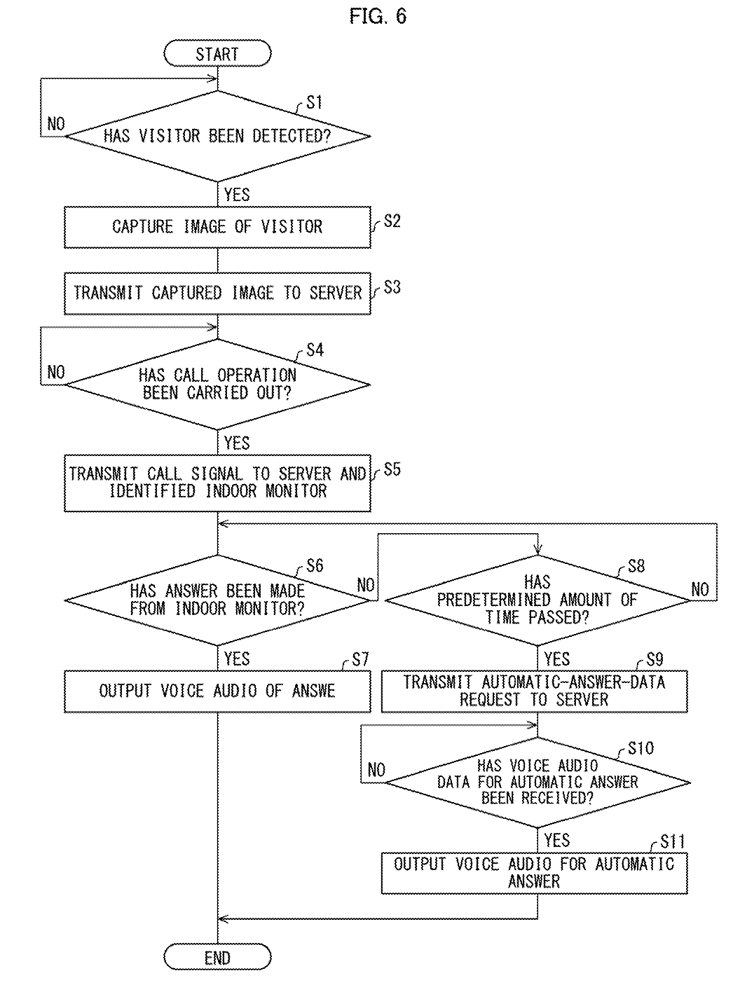

Next, the following description will discuss, with reference to FIG. 6, a flow of answer processing carried out by the shared call unit 2. FIG. 6 is a flowchart illustrating an example flow of answer processing.

First, the image capture control section 202 waits for the human sensor 22 to detect a visitor (step S1; hereinafter, the word “step” will be omitted in parentheses). In a case where the image capture control section 202 obtains, from the human sensor 22, a detection signal indicating that a visitor has been detected, the image capture control section 202 controls the image capturing section 21 so that the image capturing section 21 captures an image of the visitor (S2). The image capture control section 202 then transmits the captured image to the server 1 (S3).

The call control section 201 waits for a call operation to be inputted by the visitor (S4). In a case where the user inputs a call operation (“YES” in S4), the call control section 201 transmits a call signal to the server 1 and to the indoor monitor 3 which has been identified from an apartment number (S5). At this time, the indoor monitor 3 receives the captured image along with the call signal. The indoor monitor 3 then outputs a ringing tone and displays the captured image.

Next, the call control section 201 waits for an answer from the indoor monitor 3 (S6). In a case where there is no answer from the indoor monitor 3 (“NO” in S6), the call control section 201 continues waiting until a predetermined amount of time has passed (“NO” in S8). In a case where (i) there is an answer (“YES” in S6) and (ii) the call control section 201 has received, from the indoor monitor 3, voice audio data as the answer, the call control section 201 controls the voice audio output section 26 so that the voice audio output section 26 uses the voice audio data to output voice audio (S7). Note that in a case where the call control section 201 does not receive an answer in the form of voice audio data (such as a case where the answer consists of unlocking the front door), the processing of step S7 is omitted.

In a case where the predetermined amount of time has passed and there has been no answer from the indoor monitor 3 during the predetermined amount of time (“YES” in S8), the call control section 201 transmits an automatic-answer-data request to the server 1 (S9). The call control section 201 then waits to receive voice audio data for an automatic answer (S10). In a case where the call control section 201 receives the voice audio data (“YES” in S10), the call control section 201 controls the voice audio output section 26 so that the voice audio output section 26 uses the voice audio data to output voice audio. In other words, the call control section 201 controls the voice audio output section 26 so that the voice audio output section 26 outputs voice audio for an automatic answer (S11). The answer processing then ends.

(Flow of Processing for Determining Content of Answer)

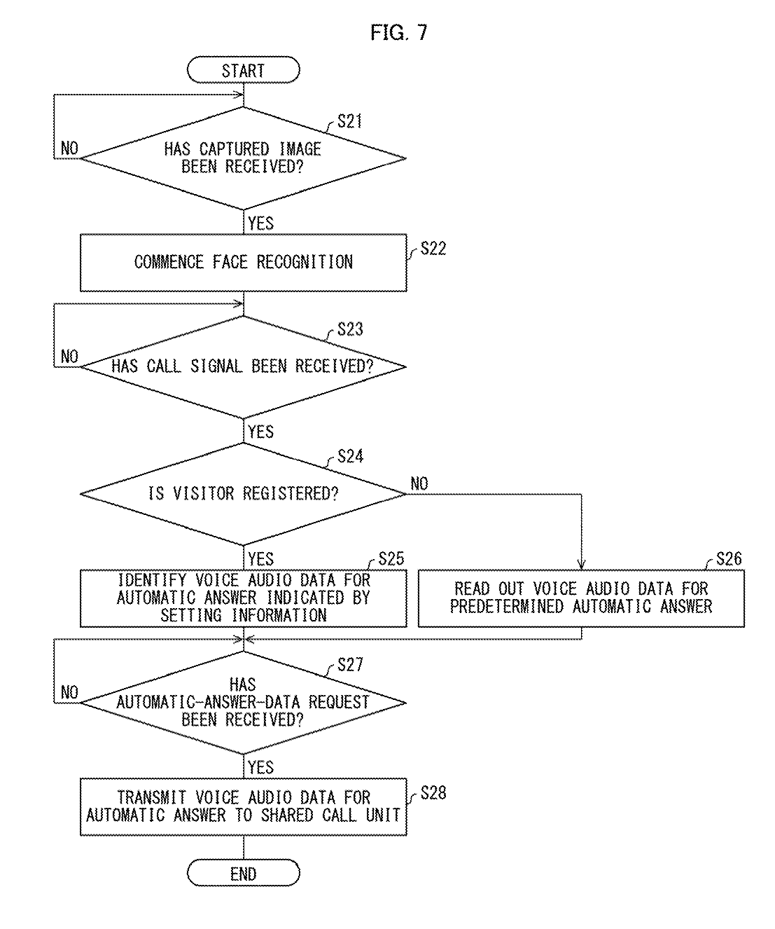

Next, the following description will discuss, with reference to FIG. 7, a flow of processing, carried out by the server 1, for determining the content of an answer. FIG. 7 is a flowchart illustrating an example flow of the processing for determining the content of an answer.

First, the output control section 101 waits to receive a captured image (S21). In a case where the output control section 101 receives the captured image (“YES” in S21), the output control section 101 supplies the captured image to the face recognition section 102. After obtaining the captured image, the face recognition section 102 commences face recognition (S22). Specifically, the face recognition section 102 extracts facial characteristics from the captured image.

Next, the output control section 101 waits to receive a call signal (S23). In a case where the output control section 101 receives a call signal (“YES” in S23), the output control section 101 supplies the call signal to the face recognition section 102. After obtaining the call signal, the face recognition section 102 determines whether or not there is visitor information 190 including a face image 901 having the extracted facial characteristics, in a column of the face image DB 111 indicated by the monitor ID included in the call signal. In other words, the face recognition section 102 determines whether or not the visitor is registered in the face image DB 111 (S24).

In a case where the visitor is registered in the face image DB 111 (“YES” in S24), the face recognition section 102 reads out the piece of the visitor information 190 representing the visitor and supplies the piece of the visitor information 190 to the output control section 101. The output control section 101 then identifies voice audio data, for an automatic answer, which is indicated by the setting information of the piece of the visitor information 190 that has been obtained (S25). Specifically, the output control section 101 identifies, from the piece of the visitor information 190 that has been obtained, the type of the visitor or the symbol 902 indicating the type. The output control section 101 then identifies voice audio data corresponding to the type or the symbol 902 thus identified and reads out the voice audio data.

In a case where the visitor is not registered in the face image DB 111 (“NO” in S24), the face recognition section 102 notifies the output control section 101 of such. After receiving such a notification, the output control section 101 identifies voice audio data for a predetermined automatic answer and reads out the voice audio data (S26).

Next, the output control section 101 waits for an automatic-answer-data request (S27). In a case where the output control section 101 receives the automatic-answer-data request (S27), the output control section 101 transmits, to the shared call unit 2, voice audio data for the automatic answer, which voice audio data the output control section 101 has read out (S28). The processing for determining the content of the answer then ends.

Note that the shared call unit 2 may transmit, to the server 1, a notification indicating that an answer has been carried out from the indoor monitor 3. In such a case, receipt of the notification may trigger the server 1 to end the processing for determining the content of the answer, even if the processing of step S28 has not been carried out.

Furthermore, the present embodiment discusses an example in which the shared call unit 2 measures time elapsed after the call operation, but this measurement may alternatively be carried out by the server 1. In such a configuration, in a case where (i) the output control section 101 of the server 1 commences measurement of time elapsed since receipt of a call signal and (ii) a predetermined amount of time passes without the output control section 101 receiving a notification indicating that an answer has been carried out from the indoor monitor 3, the output control section 101 transmits voice audio data for an automatic answer to the shared call unit 2.

(Variation)

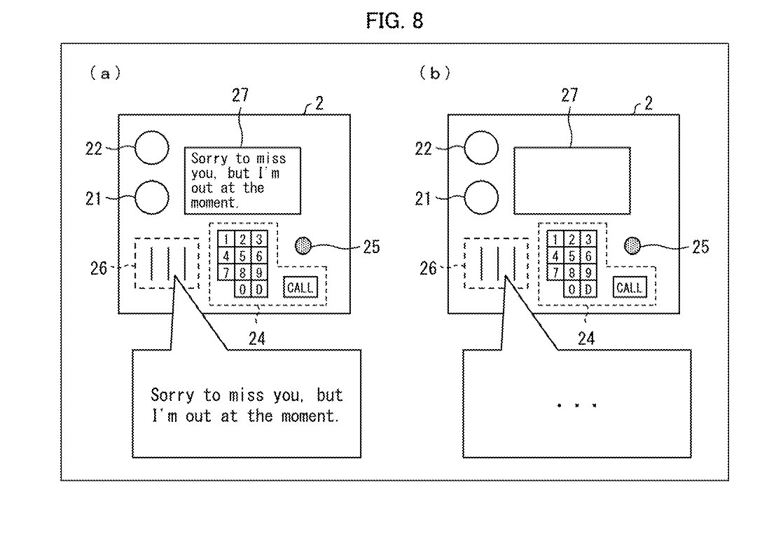

FIG. 8 is a diagram illustrating an example of an automatic answer in accordance with a variation of the present embodiment. The output control section 101 may be configured such that in a case where the visitor is not registered in the face image DB 111, the output control section 101 controls the shared call unit 2 so that the shared call unit 2 does not carry out an automatic answer, as illustrated in (b) of FIG. 8. In a case where the visitor is registered in the face image DB 111, the output control section 101 can control the shared call unit 2 so that the shared call unit 2 carries out an automatic answer using whichever voice audio data is indicated by setting information, as in the examples described above (see (a) of FIG. 8). The example of (a) of FIG. 8 illustrates an automatic answer for a visitor who is an acquaintance or friend. With such a configuration, a suspicious person will not be made aware of the resident's absence. Such a configuration therefore improves safety with regards to crime prevention.

### Embodiment 2

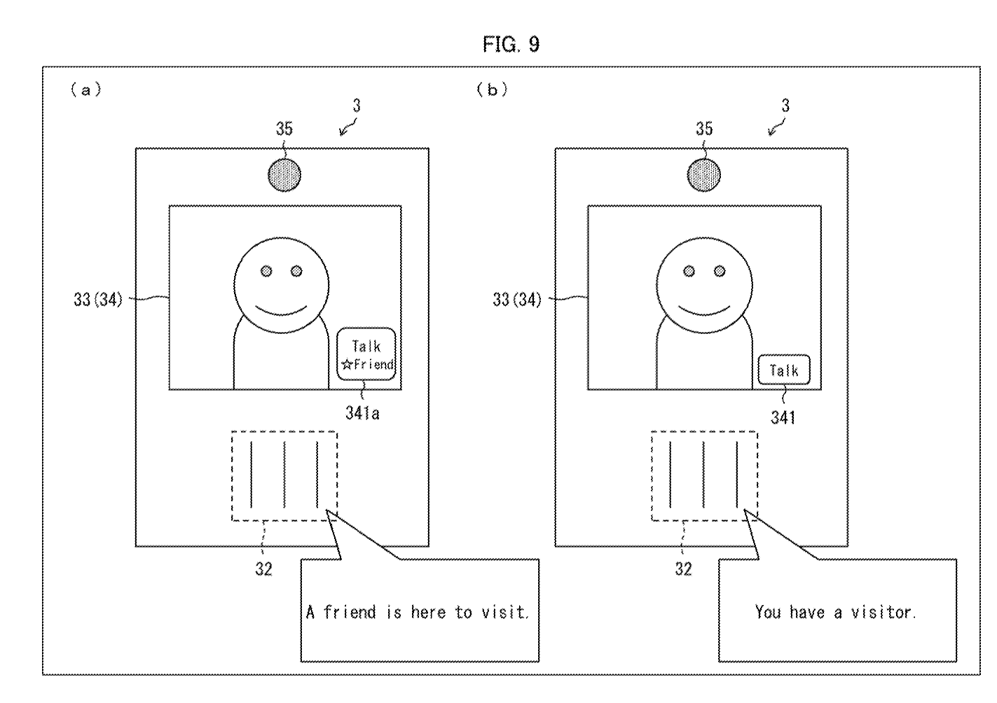

The following description will discuss, with reference to FIGS. 9 to 14, another embodiment in accordance with the present invention. For convenience, members similar in function to those described in the foregoing embodiment(s) will be given the same reference signs, and their description will be omitted.

A server 1 in accordance with the present embodiment is configured so that, in a case where a visitor carries out a call operation from a shared call unit 2, the server 1 carries out face recognition of the visitor and controls an indoor monitor 3 so that the indoor monitor 3 perform a call action (notification) in accordance with the result of the face recognition. Voice audio data 112 in accordance with the present embodiment includes a plurality of pieces of voice audio data (notification voice audio data) which can be used when the indoor monitor 3 performs a call action involving output of voice audio. In a case where an output control section 101 obtains a piece of visitor information 190 from a face recognition section 102, the output control section 101 reads out notification voice audio data in accordance with setting information contained in the piece of visitor information 190. The output control section 101 then controls an intercom communication section 12 so that the intercom communication section 12 transmits the voice audio data to the indoor monitor 3. The notification voice audio data is transmitted to the indoor monitor 3 via an apartment building controller 5 and an intercom control device 4. In other words, the apartment building controller 5 in accordance with the present embodiment connects the server 1 and the indoor monitor 3 in a manner so as to enable communication between the server 1 and the indoor monitor 3. The intercom control device 4 in accordance with the present embodiment transmits, to the indoor monitor 3, the notification voice audio data received from the server 1.

In addition to transmitting the notification voice audio data, the output control section 101 may transmit setting information to the indoor monitor 3. Specifically, the output control section 101 may transmit a type and/or a symbol 902 of the visitor, contained in the piece of visitor information 190, to the indoor monitor 3.

In a case where the output control section 101 obtains, from the face recognition section 102, a notification indicating that the visitor is not registered in a face image DB 111, the output control section 101 reads out a predetermined piece of notification voice audio data and transmits the piece of notification voice audio data to the indoor monitor 3.

The intercom control device 4 in accordance with the present embodiment is configured such that, in a case where intercom control device 4 receives notification voice audio data transmitted from the server 1, the intercom control device 4 transmits, to the indoor monitor 3, (i) the notification voice audio data, (ii) a call signal received from the shared call unit 2, and (iii) a captured image received from the shared call unit 2.

The indoor monitor 3 in accordance with the present embodiment is configured such that, in a case where the indoor monitor 3 receives (i) the call signal, (ii) the captured image, and (iii) the notification voice audio data from the intercom control device 4, the indoor monitor 3 performs a call action. FIG. 9 is a diagram illustrating how the indoor monitor 3 in accordance with the present embodiment operates. Illustrated in (a) of FIG. 9 is a call action performed in a case where the face recognition section 102 has read out the visitor information 190a, i.e., in a case where the visitor is a friend who has been registered in the face image DB 111. A control section 30 controls a voice audio output section 32 so that the voice audio output section 32 outputs voice audio for the phrase “A friend is here to visit,” as illustrated in (a) of FIG. 9. Voice audio data for this voice audio is notification voice audio data which the output control section 101 has identified by referring to the visitor's type or symbol 902 included in the visitor information 190a. This allows the resident to quickly ascertain what sort of person the visitor is (in the illustrated example, the resident can quickly ascertain that the visitor is a friend). The control section 30 may be configured so that, in a case where the control section 30 receives the type or the symbol 902 of the visitor along with the notification voice audio data, the control section 30 controls the display section 33 so that the display section 33 displays a UI 341a as illustrated in (a) of FIG. 9, instead of the UI 341 described in Embodiment 1. As illustrated in (a) of FIG. 9, the UI 341a includes the type of the visitor and a symbol indicating the type. This allows the resident to identify what sort of person the visitor is before answering, even if the resident did not hear the voice audio.

As described above, the voice audio outputted by the indoor monitor 3 changes in accordance with the recognition result from the face recognition section 102, i.e., in accordance with which piece of the visitor information 190 is read out. For example, in a case where the face recognition section 102 has read out visitor information 190b, the content of the notification voice audio data that the output control section 101 will transmit to the indoor monitor 3 (that is, the voice audio to be outputted by the indoor monitor 3) may be the phrase “You have received mail.” In another example, in a case where the face recognition section 102 has read out visitor information 190c, the voice audio to be outputted by the indoor monitor 3 may be the phrase “Please beware. A solicitor is at the door.”

Illustrated in (b) of FIG. 9 is a call action to be carried out in a case where the face recognition section 102 provides a notification indicating that the face recognition section 102 could not identify a piece of the visitor information 190, i.e., in a case where the visitor is not registered in the face image DB 111. As illustrated in (b) of FIG. 9, the control section 30 may control the voice audio output section 32 so that the voice audio output section 32 outputs voice audio that is usable regardless of the visitor. In the illustrated example, this voice audio is the phrase “You have a visitor.” Alternatively, the control section 30 may control the voice audio output section 32 so that the voice audio output section 32 outputs voice audio which allows the resident to easily ascertain that the visitor is not registered, such as the phrase “An unregistered visitor is here.” The voice audio data for such voice audio is predetermined notification voice audio data which has been identified by the output control section 101 in accordance with the notification from the face recognition section 102.

(Processing Carried Out in a Case where Face Recognition Fails)

Presumably, there are cases in which, depending on the position at which a visitor stands, a captured image will not contain the entirety of the visitor's face. For example, in some cases, a salesperson will carry out call operation while intentionally standing in a position where the salesperson's face will not be captured, in order to avoid being identified. In such a case, the face recognition section 102 will not be able to extract facial characteristics, and face recognition will fail. If the indoor monitor 3 performs a call action in a case where face recognition has failed, the intercom system 100 may cause the resident to respond in an manner undesired by the resident (for example, conversing with a salesperson).

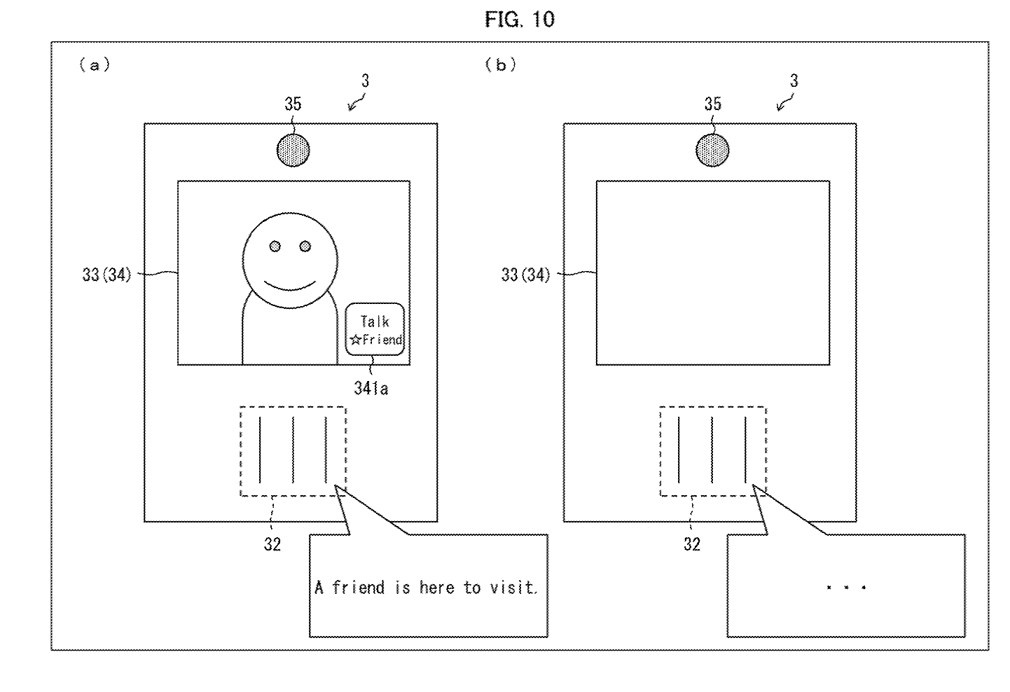

FIG. 10 is a diagram illustrating another example of how the indoor monitor 3 in accordance with the present embodiment operates. (a) of FIG. 10 is a diagram illustrating how the indoor monitor 3 operates in a case where the face recognition section 102 has carried out face recognition successfully. Specifically, as described above, the output control section 101 transmits, to the indoor monitor 3, notification voice audio data in accordance with the setting information. The control section 30 then controls the voice audio output section 32 so that the voice audio output section 32 outputs voice audio for calling the resident. The notification voice audio data transmitted to the indoor monitor 3 may be predetermined notification voice audio data in accordance with a notification indicating that the visitor is not registered.

On the other hand, (b) of FIG. 10 is a diagram illustrating how the indoor monitor 3 operates in a case where the face recognition section 102 has carried out face recognition unsuccessfully. In a case where the face recognition by the face recognition section 102 has failed, the face recognition section 102 notifies the output control section 101 of such. The output control section 101 transmits the notification (notification of recognition failure) to the intercom control device 4 via the apartment building controller 5. Although the intercom control device 4 transmits the notification of recognition failure to the indoor monitor 3, the intercom control device 4 does not receive notification voice audio data and therefore does not transmit the call signal to the indoor monitor. The indoor monitor 3 therefore does not perform a call action, as illustrated in (b) of FIG. 10. As such, the resident is not notified of the visitor's presence. This makes it possible to prevent the resident from responding in an undesired manner.

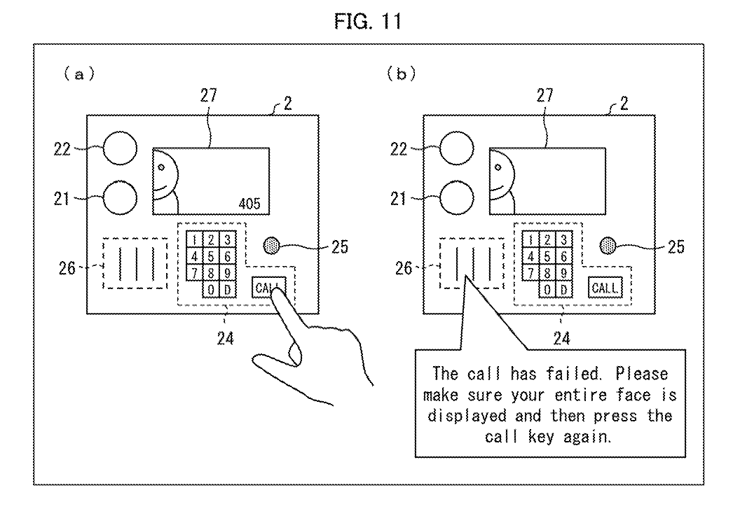

The server 1 may control the shared call unit 2 so that the shared call unit 2 outputs a notification in accordance with the failed face recognition. FIG. 11 is a diagram illustrating how the shared call unit 2 operates in a case where the face recognition has failed.

Specifically, in a case where the face recognition by the face recognition section 102 has failed, the face recognition section 102 supplies notification of such (notification of recognition failure) to the output control section 101. Then, in a case where the output control section 101 receives a call signal, the output control section 101 transmits the notification of recognition failure to the shared call unit 2. Here, “a case where the face recognition by the face recognition section 102 has failed” refers to a case where the facial characteristics cannot be sufficiently extracted from a face included in a captured image. Examples of failed face recognition include a case where the entirety of a visitor's face has not been captured, due to the visitor standing either (i) outside the image capture range of the image capturing section 21 or (ii) in the vicinity of a boundary of the image capture range, as illustrated in (a) of FIG. 11. Other examples include (i) a case where the visitor is wearing sunglasses or a face mask and (ii) a case where lighting of the visitor is insufficient.

After the shared call unit 2 receives the notification of recognition failure, a call control section 201 of the shared call unit 2 controls the voice audio output section 26 so that the voice audio output section 26 outputs voice audio with use of voice audio data (alert voice audio data) for notifying the visitor of recognition failure. The alert voice audio data may be stored in the shared call unit 2, or may be stored in the server 1 and then transmitted to the shared call unit 2 from the server 1 along with the notification of recognition failure. The voice audio to be outputted may (i) notify the visitor that a call action has not been performed by the indoor monitor 3 and (ii) prompt the visitor to stand in a position such that the entirety of the visitor's face is shown in the captured image. In the example illustrated in (b) of FIG. 11, this voice audio is for the phrase “The call has failed. Please make sure your entire face is displayed and then press the call key again.” Note that the content of the voice audio is not limited to this example. For example, the voice audio may include a notification indicating that the face recognition has failed. The voice audio may include, in addition to the above content, instructions such as “If you are wearing sunglasses and/or a face mask, please remove them.” The call control section 201 may control the display section 27 so that the display section 27 displays a message whose content is the same as the above voice audio, along with (or instead of) the outputting of the voice audio.

This configuration makes it possible to prompt the visitor to stand in a position such that the entirety of the visitor's face is shown in the captured image. Presumably, upon receiving such notification, a visitor who does not want his/her face to be identified will avoid attempting further calls. In other words, this configuration makes it possible to eliminate visitors who do not want their faces to be identified.

The output control section 101 may be configured such that in a case where the output control section 101 has obtained a notification of recognition failure from the face recognition section 102, the output control section 101 transmits the notification of recognition failure to the shared call unit 2 before receiving a call signal. With such a configuration, it is possible for the call control section 201 to control the shared call unit 2 so that the shared call unit outputs voice audio or carries out display before the visitor presses the call key, so as to make the visitor aware of the fact that a call to the resident will fail. Furthermore, in the above configuration, the face recognition section 102 may be configured such that, instead of sending the notification of recognition failure, the face recognition section 102 notifies the output control section 101 of whether or not the face recognition section 102 was able to adequately extract facial characteristics.

In a case where the output control section 101 receives a notification indicating that the face recognition section 102 was able to adequately extract facial characteristics, the output control section 101 transmits, to the shared call unit 2, a notification indicating that it is possible to make a call to the resident. Conversely, in a case where the output control section 101 receives a notification indicating that the face recognition section 102 was not able to adequately extract facial characteristics, the output control section 101 transmits, to the shared call unit 2, a notification indicating that it is not possible to make a call to the resident. With such a configuration, it is possible for the call control section 201 to make the visitor aware, before the visitor presses the call key, of whether or not it is possible to call the resident. For example, in a case where the call control section 201 has received a notification indicating that it is possible to make a call, the call control section 201 controls the display section 27 so that the display section 27 displays text which reads, “Call can be made.” Conversely, in a case where the call control section 201 has received a notification indicating that it is not possible to make a call, the call control section 201 controls the display section 27 so that the display section 27 displays text which reads, “Call cannot be made.”

In this way, by providing a notification to the visitor before the visitor presses the call key, it is possible to prevent the visitor from pressing the call key numerous times. This improves user-friendliness.

(Flow of Processing for Determining Content of Call Action)

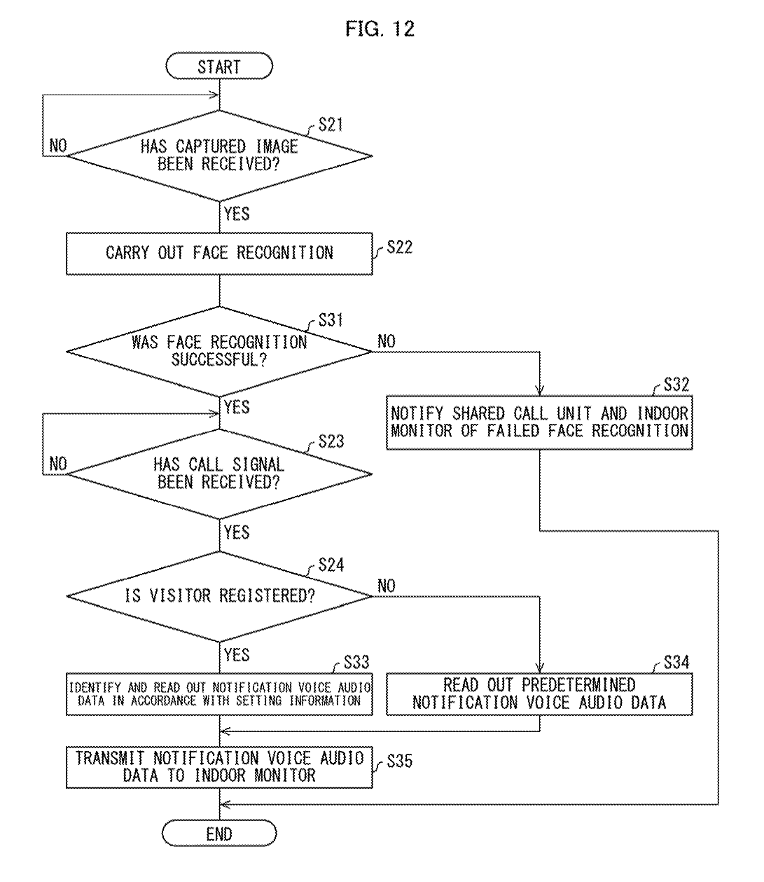

Next, the following description will discuss, with reference to FIG. 12, a flow of processing, carried out by the server 1, for determining the content of a call action. FIG. 12 is a flowchart illustrating an example flow of the processing for determining the content of a call action. Note that steps which are similar to those of the processing for determining the content of an answer, as described in Embodiment 1 with reference to FIG. 7, are given the same step number as in FIG. 7, and descriptions of such steps are omitted here.

After step S22, the output control section 101 determines whether or not the face recognition section 102 successfully carried out face recognition (S31). Specifically, the output control section 101 determines (i) whether or not a recognition result has been obtained from the face recognition section 102 or (ii) whether or not a notification of face recognition failure has been obtained from the face recognition section 102. Note that in a case where the output control section 101 receives a notification indicating that the visitor is not registered in the face image DB 111, the output control section 101 determines that a recognition result has been obtained.

In a case where the output control section 101 determines that face recognition has been successfully carried out (“YES” in S31), the processing for determining the content of the call action proceeds to step S23. In the case of “YES” in step S24, the face recognition section 102 reads out a piece of the visitor information 190 which represents the visitor and supplies the piece of the visitor information 190 to the output control section 101. The output control section 101 then identifies and reads out notification voice audio data which is indicated by the setting information of the piece of the visitor information 190 obtained from the face recognition section 102 (S33). Conversely, in the case of “NO” in step S24, the face recognition section 102 notifies the output control section 101 that the visitor is not registered. In a case where the output control section 101 receives such a notification, the output control section 101 identifies predetermined notification voice audio data and reads out the voice audio data (S34). The output control section 101 transmits, to the indoor monitor 3, the notification voice audio data which has been read out (S35). The processing for determining the content of the call action then ends.

In a case where the face recognition of step S31 has failed (“NO” in S31), the output control section 101 notifies the shared call unit 2 and the indoor monitor 3 that the face recognition has failed (S32). The processing for determining the content of the call action then ends.

(Flow of Call Processing)

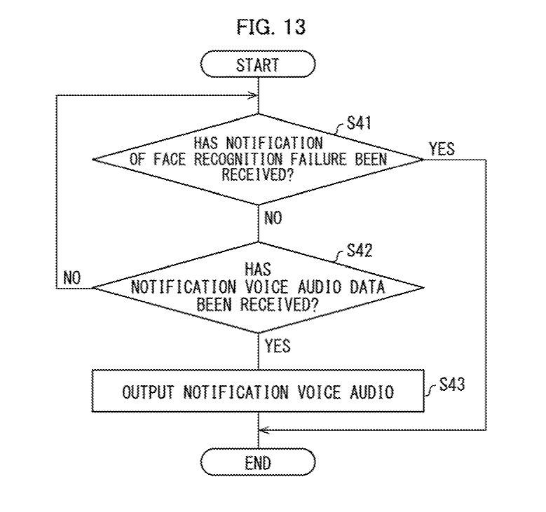

Next, the following description will discuss, with reference to FIG. 13, a flow of call processing carried out by the indoor monitor 3. FIG. 13 is a flowchart illustrating an example flow of call processing.

The control section 30 waits to receive either a notification of recognition failure (S41) or notification voice audio data (S42). In a case where (i) the control section 30 has not received a notification of recognition failure (“NO” in S41) but (ii) the control section 30 has received notification voice audio data (“YES” in S42), the control section 30 performs a call action. In other words, the control section 30 controls the voice audio output section 32 so that the voice audio output section 32 uses the notification voice audio data to output notification voice audio (S43).

In a case where the control section 30 receives a notification of recognition failure (“YES” in S41), the call processing ends. In other words, the processing of step S43 is not carried out.

(Flow of Answer Processing)

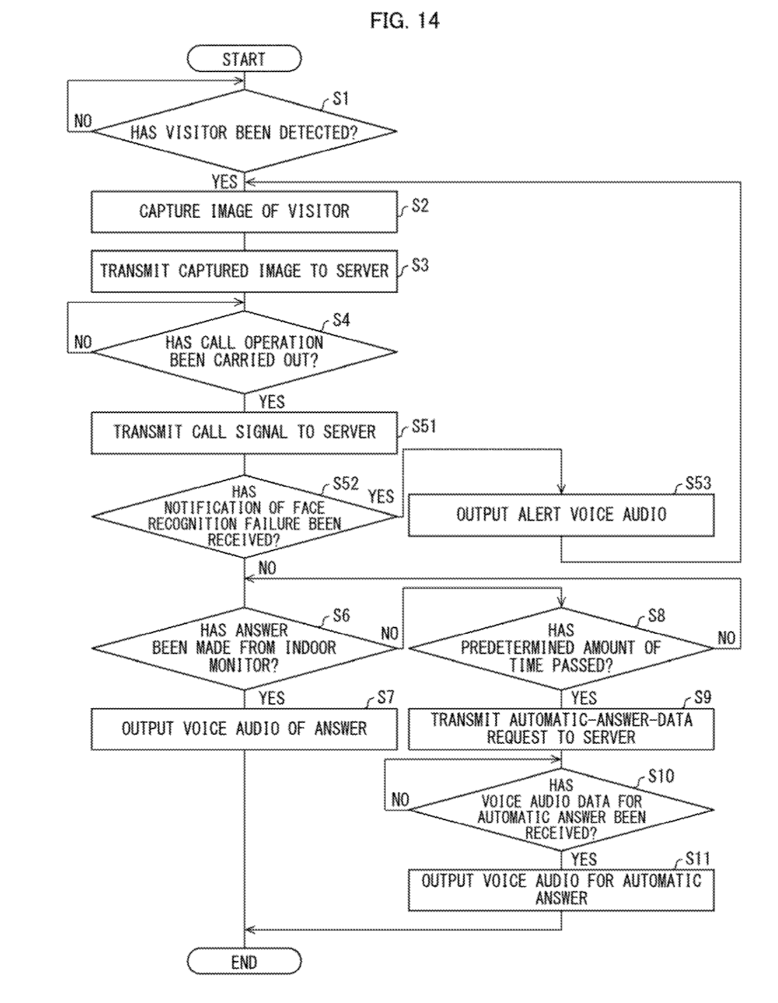

Next, the following description will discuss, with reference to FIG. 14, a flow of answer processing carried out by the shared call unit 2. FIG. 14 is a flowchart illustrating another example flow of answer processing. Note that steps which are similar to those of the answer processing as described in Embodiment 1 with reference to FIG. 6 are given the same step number as in FIG. 6, and descriptions of such steps are omitted here.

As illustrated in FIG. 14, the shared call unit 2 of the present embodiment includes a function of carrying out the answer processing described in Embodiment 1. In other words, the configuration of Embodiment 2 can be applied to Embodiment 1.

After step S4, the call control section 201 transmits a call signal to the server 1 (S51). Note that the call signal intended for the indoor monitor 3 is held by the intercom control device 4. The call signal is transmitted to the indoor monitor 3 in a case where the intercom control device 4 receives notification voice audio data from the server 1.

The call control section 201 waits to receive (i) voice audio of an answer from the indoor monitor 3 or (ii) a notification of recognition failure from the server 1 (S52). In a case where the call control section 201 receives a notification of recognition failure (“YES” in S52), the call control section 201 controls the voice audio output section 26 so that the voice audio output section 26 uses the alert voice audio data to output a voice audio alert (S53). The answer processing then returns to step S2. The call control section 201 may control the display section 27 so that the display section 27 displays text whose content is the same as the voice audio alert, in concurrence with the output of the voice audio alert.

### Embodiment 3

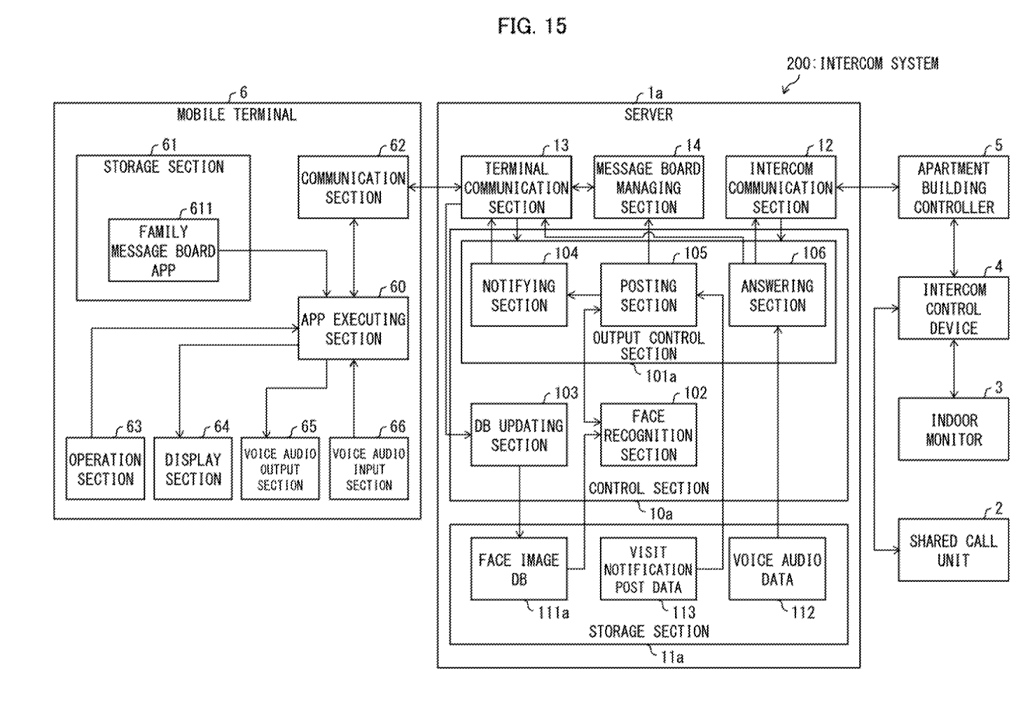

The following description will discuss, with reference to FIGS. 15 to 22, yet another embodiment in accordance with the present invention. For convenience, members similar in function to those described in the foregoing embodiment(s) will be given the same reference signs, and their description will be omitted.

FIG. 15 is a block diagram illustrating an example configuration of main parts of devices included in an intercom system 200 in accordance with the present embodiment. As illustrated in FIG. 15, the intercom system 200 includes a server 1a, a shared call unit 2, an indoor monitor 3, an intercom control device 4, an apartment building controller 5, and a mobile terminal 6 (telephonic conversation device). Note that the configuration of the main parts of the shared call unit 2 and the indoor monitor 3 is similar to that illustrated in FIG. 1 and is therefore not shown in FIG. 15.

(Intercom System 200)

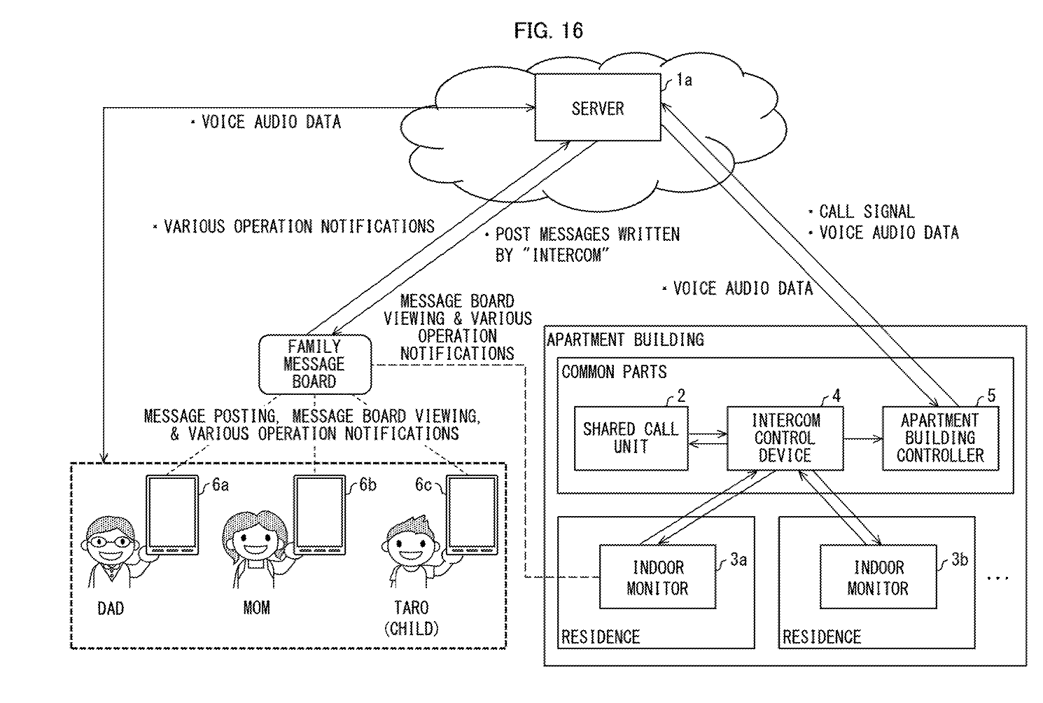

FIG. 16 is a diagram schematically illustrating the intercom system 200 in accordance with the present embodiment. The intercom system 200 is a system which manages, for example, calls from visitors to residents, telephonic conversation between visitors and residents, and unlocking of the front door by residents, each of which was described in Embodiments 1 and 2. The intercom system 200 further provides an electronic message board (a so-called social networking service) which enables sharing of information between pre-registered users (in the example of FIG. 16, these users are “Dad,” “Mom,” and “Taro” (a child)). The pre-registered users are able to view the electronic message board by using, for example, a mobile terminal (for example, the mobile terminal 6).

Each electronic message board can be joined only by a user who has been invited by a user who is authorized to add more users to the electronic message board (for example, by the creator of the electronic message board). In the example of FIG. 16, only Mom and Taro have been invited to an electronic message board created by Dad. In other words, the electronic message board in accordance with the present embodiment is an electronic message board (family message board) viewable only by members of a family. Note that in the following descriptions, when distinction is necessary, the mobile terminals 6 belonging to Dad, Mom, and Taro will be referred to separately as a mobile terminal 6a, a mobile terminal 6b, and a mobile terminal 6c, respectively, as illustrated in FIG. 16.

Note that a person who has been invited by a user authorized to add users may join the family message board regardless of whether that person lives at the same residence. In other words, members of the family message board, i.e., users of a mobile terminal 6 with which the family message board can be viewed, are not limited to residents. For example, it is possible for a relative who lives at another residence to join the family message board.

In a case where an operation is made on the mobile terminal 6 to accept an invitation to the family message board, the server 1a obtains a user ID from the mobile terminal 6. The server 1a then adds the user ID to a database (not illustrated) as described in Embodiment 1, in which database monitor IDs are associated with user IDs. In this way, the user of the mobile terminal 6 becomes a member of the family message board. In other words, the mobile terminal 6 belonging to the user who has joined the family message board is registered in the database in the server 1a.

The intercom system 200 allows each user to view the family message board and post messages on the family message board by using his/her own mobile terminal 6. Furthermore, the intercom system 200 is configured so that in a case where a visitor uses the shared call unit 2 to call a resident (in the present embodiment, Dad, Mom, or Taro) of a certain residence, a visit notification message indicating that a visitor has come is posted to the family message board. The visit notification message is posted as a message from “Mr. Intercom,” a personification of the intercom (the shared call unit 2 and the indoor monitor 3).

Furthermore, in the intercom system 200, the mobile terminal 6 displays the family message board and accepts input of a user operation carried out on a UI included in the visit notification message, so that the user (resident) can carry out a telephonic conversation with the visitor. In other words, a resident can respond to the visitor by using the mobile terminal 6. The mobile terminal 6 is, for example, capable of communication with the server 1a via the internet, accessed through a mobile phone line. As such, even when outside the residence, the user of the mobile terminal 6 is able to use the family message board and respond to a visitor.

(Server 1a)

The server 1a posts messages to a communication service which displays posted messages in chronological order. In other words, the server 1a posts, to the family message board, visit notification messages and messages written by users with use of a mobile terminal 6. The server 1a also carries out various processing relating to the family message board, such as (i) providing a display screen (message board screen) of the family message board to the mobile terminal 6 and (ii) managing messages. Furthermore, the server 1a receives voice audio data transmitted from the mobile terminal 6 and transmits the voice audio data to the shared call unit 2, and receives voice audio data transmitted from the shared call unit 2 and transmits the voice audio data to the mobile terminal 6. In this way, a telephonic voice audio conversation between a resident and a visitor is achieved.

As illustrated in FIG. 15, the server 1a includes a control section 10a, a storage section 11a, an intercom communication section 12, a terminal communication section 13, and a message board managing section 14. The intercom communication section 12 and the terminal communication section 13 are the same as those described in Embodiment 1, and thus descriptions of such are omitted here.

The message board managing section 14 carries out various processing relating to the family message board, such as (i) providing a message board screen to the mobile terminal 6 and (ii) managing messages. Specifically, the message board managing section 14 receives post data, generated by a posting section 105 (described later) or the mobile terminal 6, and makes a post to the family message board. More specifically, in a case where the message board managing section 14 receives post data, the message board managing section 14 generates data (hereinafter, “post display data”) constituted by (i) a text string (for example, HTML data) which indicates the post data and (ii) an image, and posts the data thus generated to the family message board.

Furthermore, the message board managing section 14 transmits post display data to the mobile terminal 6 in response to a family message board acquisition request transmitted from the mobile terminal 6. The “family message board acquisition request” refers to a request for the server 1a to transmit data necessary for displaying the family message board on the mobile terminal 6. The configuration in which the message board managing section 14 transmits the post display data upon receiving the family message board acquisition request is only one example. For example, the message board managing section 14 may be configured such that whenever the message board managing section 14 generates post display data indicating new post data, the message board managing section 14 transmits the post display data thus generated to the mobile terminal 6, even without receiving a message board acquisition request.

The storage section 11a stores various types of data used by the server 1a. The storage section 11a stores at least a face image DB 111a, voice audio data 112, and visit notification post data 113. The voice audio data 112 is as described in Embodiment 1, and thus descriptions of such are omitted here.

The visit notification post data 113 is data for generating and editing a visit notification message. Specifically, examples of the visit notification post data 113 include, but are not limited to, text data, image data, and a UI, each of which can be included in a visit notification message.

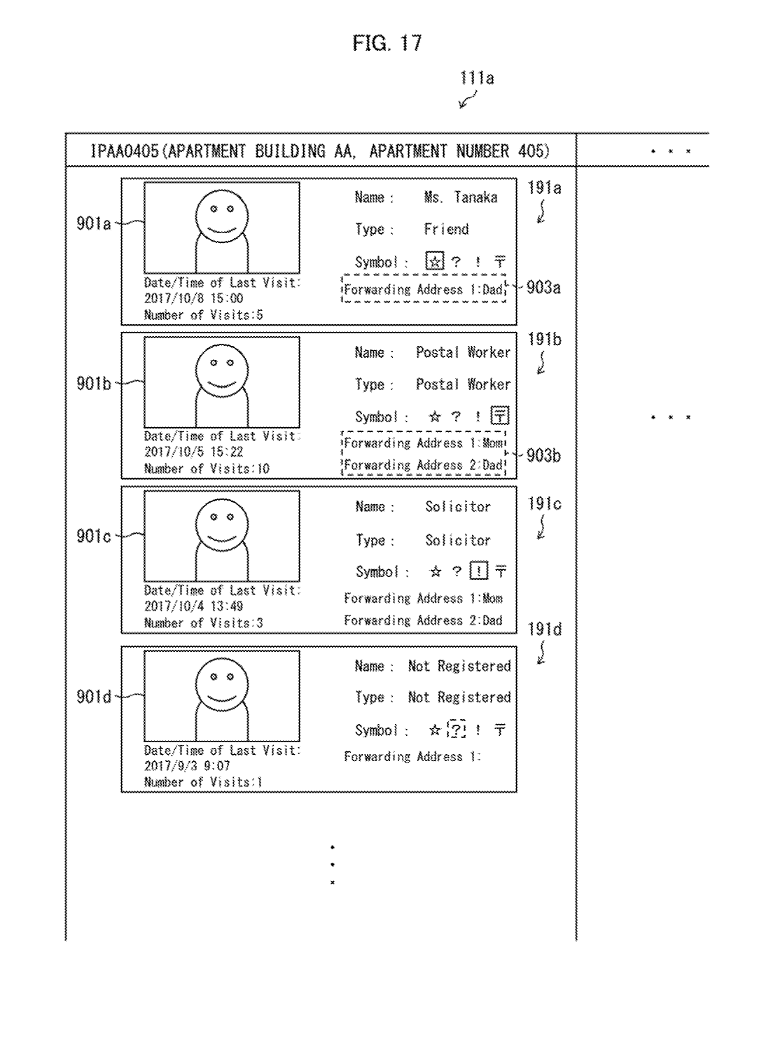

The face image DB 111a is a DB for managing visitor information, similarly to the face image DB 111 described in Embodiment 1. FIG. 17 is a diagram illustrating one specific example of the face image DB 111a. Note that a data structure and data content of the face image DB 111a are not limited to the examples illustrated in FIG. 17.

In the example of FIG. 17, visitor information 191a through 191d is stored in a column for the monitor ID “IPAA0405”. Note that in the descriptions below, in cases where it is not necessary to distinguish between the visitor information 191a through 191d, the visitor information 191a through 191d is collectively referred to as visitor information 191.

The visitor information 191 differs from the visitor information 190 described in Embodiment 1 in that the visitor information 191 includes forwarding address information 903 (a term which collectively refers to forwarding address information 903a and 903b illustrated in FIG. 17). The forwarding address information 903 is information indicating a resident who should be notified in the event of a visit made by a visitor indicated in the visitor information 191. In the present embodiment, the forwarding address information 903 is described as being included in the setting information described in the Embodiment 1.

In the case of the visitor information 191a, the forwarding address information 903a indicates that “Dad” is the resident who should be notified of a visit by the visitor. In other words, notification of a visit by the visitor indicated in the visitor information 191a is sent to the mobile terminal 6a belonging to Dad.

In the case of the visitor information 191b, the forwarding address information 903b indicates that “Mom” and “Dad” are the residents who should be notified of a visit by the visitor. In the present embodiment, in a case where there are a plurality of possible notification recipients, as is the case for the visitor information 191b, the server 1a first sends the notification to a resident for whom the number appearing after the text “Forwarding Address” is lowest. In a case where that resident does not respond to the visitor, the server 1a then sends the notification to a resident having the next lowest number. In other words, in the case of a visit by the visitor indicated by the visitor information 191b, a notification is first sent to the mobile terminal 6b belonging to Mom, and if there is no response from Mom, a notification is then sent to the mobile terminal 6a belonging to Dad. The notification of the visitor's visit which is sent to the mobile terminal 6 is described later in detail.

In FIG. 17, for the purposes of explanation, the forwarding address information 903 is shown as being “Dad”, “Mom,” etc. Note, however, that in actuality, the forwarding address information 903 is information which enables identification of a mobile terminal belonging to Mom, Dad, etc. (that is, identification of the mobile terminals 6a, 6b, etc.).

The control section 10a comprehensively controls the functions of the server 1a. The control section 10a includes an output control section 101a, a face recognition section 102, and a DB updating section 103. The face recognition section 102 and the DB updating section 103 are as described in Embodiment 1, and thus descriptions of such are omitted here.

The output control section 101a controls notifications (visit notifications) that are sent to the mobile terminal 6 to indicate that a visitor has visited. The output control section 101a includes a notifying section 104, a posting section 105, and an answering section 106.

The posting section 105 generates a visit notification message and controls the message board managing section 14 so that the message board managing section 14 posts the visit notification message to the family message board. Specifically, in a case where the posting section 105 obtains, from the intercom communication section 12, a captured image transmitted from the shared call unit 2, the posting section 105 supplies the captured image to the face recognition section 102 and controls the face recognition section 102 so that the face recognition section 102 carries out face recognition. In a case where the posting section 105 receives, from the apartment building controller 5 and via the intercom communication section 12, a call signal including a monitor ID, the posting section 105 supplies the call signal to the face recognition section 102.

In a case where the posting section 105 obtains a piece of the visitor information 191 as a recognition result from the face recognition section 102, the posting section 105 identifies a type or a symbol of the visitor included in that piece of the visitor information 191. The posting section 105 then uses the visit notification post data 113 to generate a visit notification message whose content is in accordance with the type or the symbol thus identified. In a case where the posting section 105 receives, from the face recognition section 102, a notification indicating that a piece of the visitor information 191 could not be identified, the posting section 105 generates a visit notification message (predetermined visit notification message) for use in a case where a piece of the visitor information 191 could not be identified. The posting section 105 supplies the visit notification message thus generated to the message board managing section 14 and controls the message board managing section 14 so that the message board managing section 14 posts the visit notification message to the family message board.

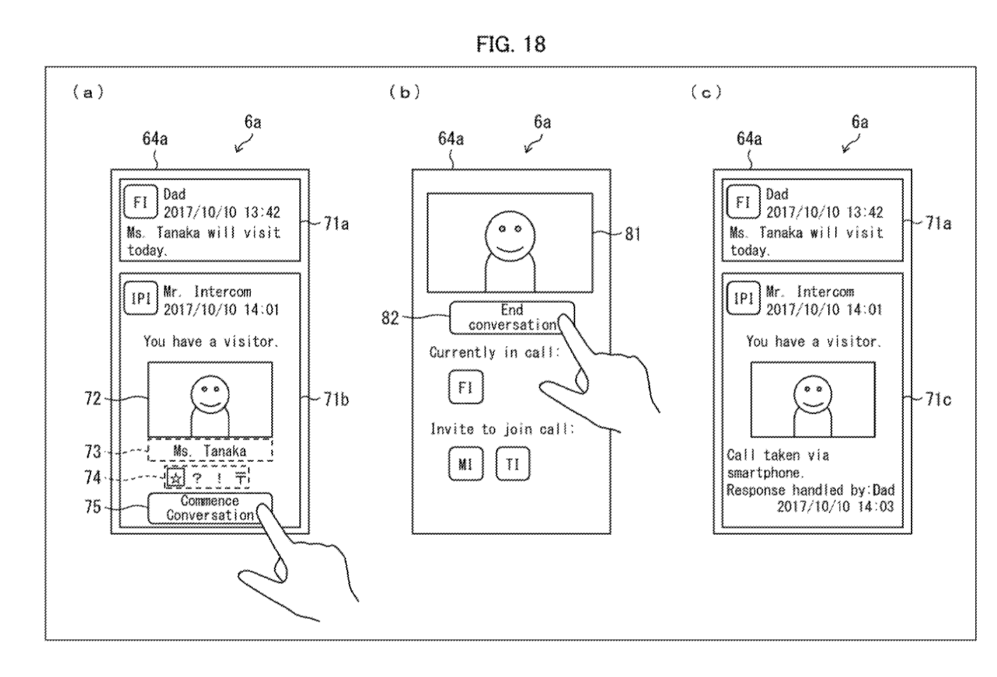

FIG. 18 illustrates message board screens to be displayed on the mobile terminal 6 and a transition from the message board screen. (a) of FIG. 18 illustrates a message board screen to be displayed when a visitor (Ms. Tanaka) indicated by the visitor information 191a (see FIG. 17) is making a visit.

In a case where Ms. Tanaka makes a visit, the posting section 105 obtains the visitor information 191a from the face recognition section 102. The posting section 105 then generates a visit notification message 71b illustrated in (a) of FIG. 18. Specifically, from the visitor information 191a, the posting section 105 reads out text 73 indicating the name of the visitor and a symbol 74. The posting section 105 then includes the text 73 and the symbol 74 in the visit notification message. The posting section 105 also generates a face image 72 of the visitor by taking a still image from the captured image and includes the face image 72 in the visit notification message. The posting section 105 also reads out, from the visit notification post data 113, text indicating the poster (Mr. Intercom), an icon indicating the poster, and a UI 75, and includes the text, the icon, and the UI 75 in the visit notification message. The posting section 105 also includes, in the visit notification message, the current date/time (2017/10/10 14:01) as the date/time of the post. In this way, the visit notification message 71b is generated, and then posted to the family message board by the message board managing section 14. Note that a face image 901 included in the visitor information 191 may be used as the face image 72. However, in view of the possibility of incorrect face recognition, it is preferable to use a face image taken from the captured image. Alternatively, it is possible for the face image 72 used in the visit notification message to include both (i) an image taken from the captured image and (ii) a face image 901 included in the identified piece of the visitor information 191.

The message board managing section 14 arranges posts in chronological order. As such, in the illustrated example, the visit notification message 71b is arranged so as to be directly beneath a post 71a.

In a case where (i) a visitor not registered in the face image DB 111a makes a visit and (ii) the posting section 105 receives, from the face recognition section 102, a notification indicating that a piece of the visitor information could not be identified, the posting section 105 generates a visit notification message which includes neither the text 73 indicating a name of the visitor nor the symbol 74.

Furthermore, once the posting section 105 supplies the visit notification message to the message board managing section 14, the posting section 105 notifies the notifying section 104 of such. In a case where the posting section 105 has obtained a piece of the visitor information 191, the posting section 105 supplies forwarding address information 903 included in the piece of the visitor information 191 to the notifying section 104, along with the above notification.

The answering section 106 controls a telephonic conversation between the resident and the visitor, which conversation is carried out with use of the mobile terminal 6 and the shared call unit 2. Specifically, in a case where the answering section 106 receives a telephonic-conversation commencement instruction from the mobile terminal 6, the answering section 106 connects the mobile terminal 6 and the shared call unit 2 in a manner so as to enable a telephonic conversation. The answering section 106 then generates a telephonic conversation screen and transmits the telephonic conversation screen to the mobile terminal 6 so that the mobile terminal 6 displays the telephonic conversation screen. Note that the telephonic-conversation commencement instruction includes terminal-identifying information which enables identification of the mobile terminal 6. The telephonic-conversation commencement instruction is described later in detail.

In a case where the user of the mobile terminal 6 carries out a touch operation on the UI 75 as illustrated in (a) of FIG. 18, the mobile terminal 6 transmits the telephonic-conversation commencement instruction to the server 1a. Upon receiving the instruction, the answering section 106 generates a telephonic conversation screen, such as the one illustrated in (b) of FIG. 18, and transmits the telephonic conversation screen to the mobile terminal 6. (b) of FIG. 18 is a diagram illustrating one specific example of the telephonic conversation screen.

As illustrated in (b) of FIG. 18, the telephonic conversation screen includes a captured image 81 and a UI 82. The captured image 81 is a captured image (moving image) transmitted from the shared call unit 2 to the server 1a. The UI 82 is for ending the telephonic conversation with the visitor. The telephonic conversation screen also includes text and an icon(s), as illustrated. The icons illustrated (icons containing the letters “FI,” “MI,” and “TI”) are described later in detail. Note that the UI 82, the text, and the icons may be stored in the storage section 11a (this is not illustrated in FIG. 15).

In a case where the user of the mobile terminal 6 carries out a touch operation on the UI 82 as illustrated in (b) of FIG. 18, the mobile terminal 6 transmits the telephonic-conversation termination instruction to the server 1a. In a case where the answering section 106 receives the instruction, the answering section 106 disconnects the mobile terminal 6 and the shared call unit 2 so as to end the telephonic conversation.

The following description further describes the posting section 105. In a case where the posting section 105 receives a telephonic-conversation termination instruction, the posting section 105 edits the visit notification message. (c) of FIG. 18 is a diagram illustrating a message board screen. The message board screen includes a visit notification message which has been edited in accordance with termination of a telephonic conversation. Specifically, in a case where the posting section 105 receives a telephonic-conversation termination instruction, the posting section 105 generates a visit notification message 71c. The visit notification message 71c differs from the visit notification message 71b in that the text 73, the symbol 74, and the UI 75 have been deleted, and instead, (i) text reading “Call taken via smartphone”, (ii) text reading “Response handled by: Dad”, and (iii) text indicating the date/time at which the telephonic conversation ended have been added, as illustrated in (c) of FIG. 18. Note that the above text is stored in the storage section 11a as visit notification post data 113. The posting section 105 then supplies the visit notification message 71c to the message board managing section 14 and controls the message board managing section 14 so that the message board managing section 14 replaces the visit notification message 71b with the visit notification message 71c. The message board managing section 14 then transmits, to the mobile terminal 6, a display screen in which the visit notification message has been replaced thusly. In this way, the mobile terminal 6 is controlled so as to display the display screen illustrated in (c) of FIG. 18.

Note that the text reading “Call taken via smartphone” and “Response handled by: Dad” as seen in the illustration is an example of text for use a case where the response to the visitor consisted of a telephonic conversation with the visitor with use of the mobile terminal 6a. The content of the visit notification message to be displayed after a response has finished is not limited to that of visit notification message 71c. A variation of the visit notification message to be displayed after a response has finished is described later in Embodiment 4.

In the illustrated example, the posting section 105 determines that the terminal-identifying information included in the telephonic-conversation commencement instruction indicates the mobile terminal 6a and then adds the above-described text to the visit notification message. Specifically, the storage section 11a stores a database (not illustrated in FIG. 15) which associates the terminal-identifying information with text (or with information from which text can be identified). The posting section 105 refers to the database and determines the text to be added to the visit notification message.

The notifying section 104 provides, to the mobile terminal 6 belonging to a user who has joined the family message board, a notification indicating that the visit notification message has been posted. Specifically, in a case where the notifying section 104 receives (i) the notification from the posting section 105 and (ii) forwarding address information 903, the posting section 105 transmits a notification (post notification) indicating that the visit notification message has been posted. This notification is transmitted to a mobile terminal 6 indicated by a forwarding address having the lowest number among the forwarding addresses in the forwarding address information 903. In a case where (i) a predetermined amount of time has passed since notifying section 104 has transmitted the post notification and (ii) the notifying section 104 has not received a telephonic-conversation commencement instruction during the predetermined amount of time, the notifying section 104 then transmits the post notification to a mobile terminal 6 indicated by a forwarding address having the next lowest number. No post notification is transmitted to a mobile terminal 6 which is not included in the forwarding address information 903.

In a case where the notifying section 104 receives a notification from the posting section 105 but does not obtain forwarding address information 903, i.e., in a case where the visitor is not registered in the face image DB 111a, the notifying section 104 transmits a post notification to mobile terminals 6 of all residents associated with the relevant monitor ID.

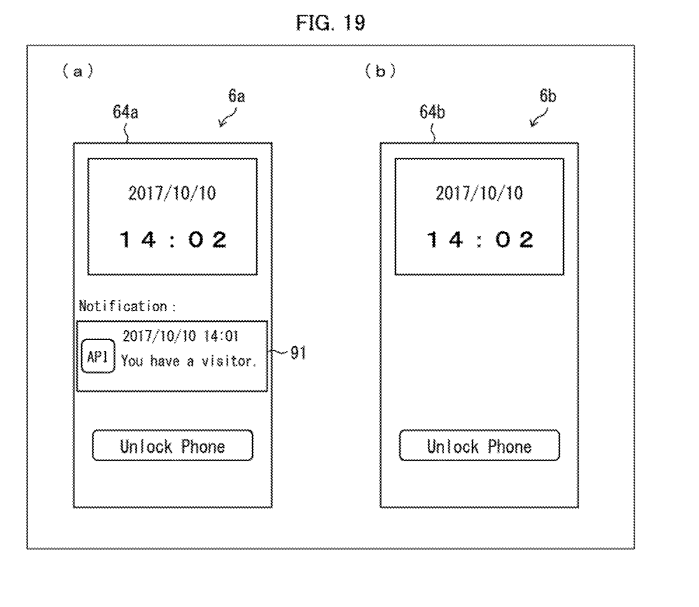

FIG. 19 is a diagram illustrating example screens, relating to a post notification, as displayed by the mobile terminal 6. Specifically, FIG. 19 illustrates example screens relating to a post notification that provides notification of the posting of a visit notification message, the visit notification message indicating that the visitor (Ms. Tanaka) indicated by visitor information 191a (see FIG. 17) is making a visit. (a) of FIG. 19 illustrates an example screen displayed on the mobile terminal 6a (the mobile terminal 6 belonging to Dad). (b) of FIG. 19 illustrates an example screen displayed on the mobile terminal 6b (the mobile terminal 6 belonging to Mom). The notifying section 104 transmits the post notification only to mobile terminal 6a, in accordance with the forwarding address information 903a that has been obtained. In this way, the user of the mobile terminal 6a is provided with a notification indicating that the visit notification message has been posted, as illustrated in (a) of FIG. 19, but the user of the mobile terminal 6b is not, as illustrated in (b) of FIG. 19.

One typical example of a notification, provided to the mobile terminal 6, indicating that a visit notification message has been posted, is a notification message 91 as illustrated in (a) of FIG. 19. The notification message 91 may be generated by the notifying section 104 and then transmitted as a post notification to the mobile terminal 6. Alternatively, the notification message 91 may be generated by the mobile terminal 6 upon receipt of the post notification. Note that the notification message 91 preferably differs from a notification message used for a case where a post other than a visit notification message is posted family message board. As such, in a configuration where the notification message 91 is generated by the mobile terminal 6, post notifications are configured so as to enable the mobile terminal 6 to distinguish between posting of a visit notification message and posting of a message other than a visit notification message.

The notification message 91 may differ in accordance with visitor information 191. For example, in a case where the notification message 91 includes a type or a symbol of a visitor, then the type or symbol included in the notification message 91 will differ between a case where the visitor information 191a has been identified and a case where the visitor information 191b has been identified. In an example configuration in which (i) the notification message 91 differs in accordance with visitor information 191 and (ii) the notification message 91 is generated by the mobile terminal 6, the post notification further includes a type or symbol contained in the piece of the visitor information 191 which has been identified.

The notification message 91 may differ between a case where a piece of the visitor information 191 (in other words, a visitor) has been identified and a case where a piece of the visitor information 191 has not been identified. In an example configuration in which (i) the notification message 91 differs in accordance with whether or not a piece of the visitor information 191 has been identified and (ii) the notification message 91 is generated by the mobile terminal 6, post notifications are configured so as to enable the mobile terminal 6 to distinguish whether or not a piece of the visitor information 191 has been identified.

(Mobile Terminal 6)

Next, the following description will discuss a configuration of main parts of the mobile terminal 6, with reference to FIG. 15. As illustrated in FIG. 15, the mobile terminal 6 includes an app executing section 60, a storage section 61, a communication section 62, an operation section 63, a display section 64, a voice audio output section 65, and a voice audio input section 66.

The storage section 61 stores various types of data used by the mobile terminal 6. The storage section 61 stores at least a family message board app 611. The family message board app 611 is an application for a family message board and is executed by the mobile terminal 6. The family message board app 611 is stored in the storage section 61 once the user of the mobile terminal 6 installs the family message board app 611 on the mobile terminal 6 by using an “application store” system which is standard in the OS of the mobile terminal 6. Alternatively, the family message board app 611 may be already stored by the storage section 61 at the time the mobile terminal 6 is sold (that is, the family message board app 611 may be preinstalled). Executing the family message board app 611 allows the mobile terminal 6 to do such things as display the family message board (for example, display the screen illustrated in (a) of FIG. 18), display a screen for generating a post, and accept user operations to generate a post. Furthermore, executing the family message board app 611 allows the mobile terminal to display a telephonic conversation screen (for example, the screen illustrated in (b) of FIG. 18) and achieve a telephonic conversation between the mobile terminal 6 and the shared call unit 2.

The communication section 62 communicates with the server 1a. Specifically, the communication section 62 transmits, to the server 1a, various information received from the app executing section 60. Examples of the various information include the above-described family message board acquisition request, the telephonic-conversation commencement instruction, the telephonic-conversation termination instruction, post data generated by the mobile terminal 6, voice audio data of telephonic conversation voice audio inputted into the mobile terminal 6 (voice audio for a telephonic conversation with a visitor). The communication section 62 also supplies, to the app executing section 60, various information received from the server 1a. Examples of the various information include the above-described message board screen, the telephonic conversation screen, the post notification, and voice audio data of telephonic conversation voice audio inputted by the visitor.

The operation section 63 obtains an operation input from the user and supplies, to the app executing section 60, a signal indicating the operation input. Typical examples of the operation section 63 include a physical button and a touch panel. Note however, that the operation section 63 may be some other input device. Descriptions of the present embodiment assume an example where at least a part of the operation section 63 is a touch panel integrated with the display section 64.

The display section 64 is controlled by the app executing section 60 so as to display various images. Specific examples of the various images include the message board screen and the telephonic conversation screen.

The voice audio output section 65 is a so-called speaker which is controlled by the app executing section 60 so as to output voice audio. The voice audio output section 65 converts, into voice audio, voice audio data of telephonic conversation voice audio inputted into the shared call unit 2 by the visitor. The voice audio output section 65 then outputs the resulting voice audio.

The voice audio input section 66 is a so-called microphone which (i) obtains voice audio generated in the vicinity of the mobile terminal 6, (ii) converts the voice audio into voice audio data, and (iii) supplies the voice audio data to the app executing section 60. A typical example of such voice audio is voice audio spoken by the user of the mobile terminal 6 (by the resident) during a telephonic conversation with the visitor.

The app executing section 60 carries out various processing related to executing the family message board app 611. Specifically, the app executing section 60 does such things as (i) starting up the family message board app 611 in accordance with an obtained signal indicating operation input, (ii) controlling the display section 64 so that the display section 64 displays a message board screen or telephonic conversation screen received from the server 1a, and (iii) terminating the family message board app 611. The app executing section 60 also generates various information, such as a telephonic-conversation commencement instruction and a telephonic-conversation termination instruction, in response to a signal indicating that a UI displayed on the message board screen or the telephonic conversation screen has been touched. The app executing section 60 transmits the various information thus generated to the server 1a. The app executing section 60 also controls the display section 64, in accordance with a post notification received from the server 1a, so that the display section 64 displays the notification message 91. During a telephonic conversation between the resident and the visitor, the app executing section 60 transmits, to the server 1a, voice audio data obtained from the voice audio input section 66 and controls the voice audio output section 65 so that the voice audio output section 65 outputs voice audio data received from the server 1a.

(Response Involving a Plurality of Users)

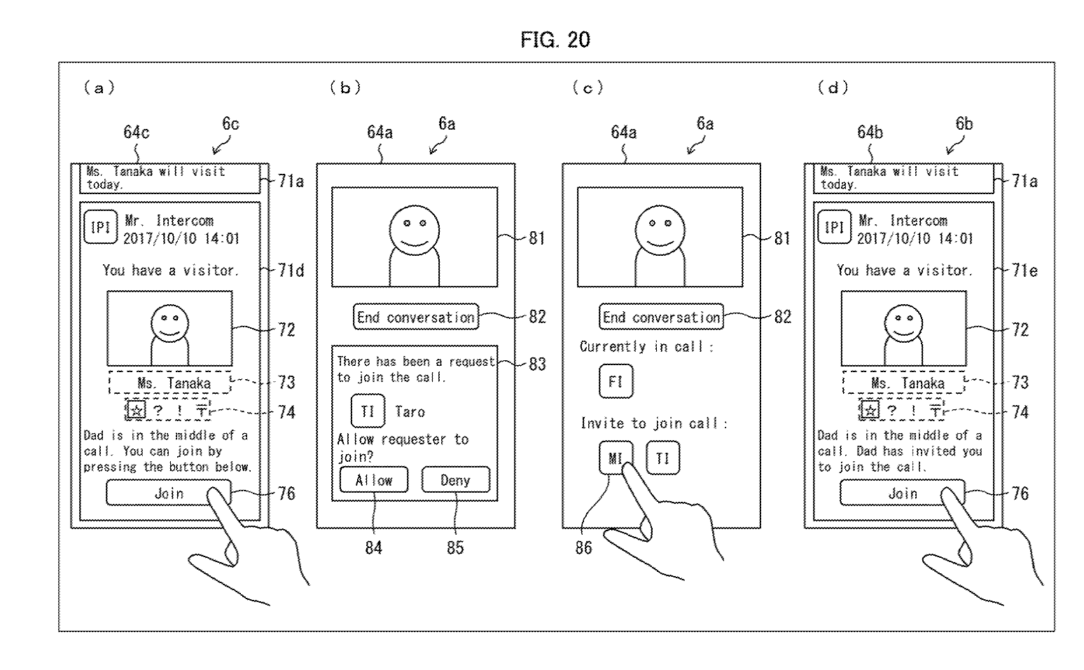

Because visit notification messages are posted to the family message board, even a user of a mobile terminal 6 which has not received a post notification can check the family message board and have a telephonic conversation with the visitor. It is also possible for a plurality of residents to participate in a telephonic conversation with a visitor. For example, in a case where a resident and a visitor are having a one-on-one telephonic conversation, it is possible to allow another resident to participate in the telephonic conversation. FIG. 20 is a diagram illustrating how a resident can be added to a telephonic conversation with a visitor.

Discussed first, with reference to (a) and (b) of FIG. 20, is an example in which a resident who is not participating in a telephonic conversation voluntarily attempts to join the telephonic conversation. (a) of FIG. 20 is a diagram illustrating an example of a message board screen displayed on the mobile terminal 6c, which belongs to Taro. A visit notification message 71d is included in the message board screen. The visit notification message 71d includes (i) text which reads “Dad is in the middle of a call. You can join by pressing the button below”, and (ii) a UI 76. In a case where Taro wishes to join the telephonic conversation with the visitor, Taro inputs, into the mobile terminal 6c, a touch operation carried out on the UI 76. In a case where the app executing section 60 obtains a signal based on the touch operation, the app executing section 60 transmits a join request notification to the server 1a. The join request notification is for adding the mobile terminal 6c to the telephonic conversation between the mobile terminal 6a and the shared call unit 2.

(b) of FIG. 20 is a diagram illustrating an example of a telephonic conversation screen which is displayed, on the mobile terminal 6a belonging to Dad, after Taro has made the join request. In a case where the answering section 106 receives the join request notification, the answering section 106 generates a telephonic conversation screen including a participant selection image 83 as illustrated in (b) of FIG. 20. The answering section 106 then transmits the telephonic conversation screen to the mobile terminal 6a. The participant selection image 83 includes (i) an allow button 84 for giving Taro permission to join, and (ii) a deny button 85 for denying Taro permission to join.

In a case where the app executing section 60 of the mobile terminal 6a receives the telephonic conversation screen including the participant selection image 83, the app executing section 60 replaces the currently displayed telephonic conversation screen (the screen illustrated in (b) of FIG. 18) with the telephonic conversation screen that has been received. This makes it possible for Dad to choose whether or not to allow Taro to join the telephonic conversation. It is possible for Dad to allow Taro to join the telephonic conversation by carrying out a touch operation on the allow button 84. Specifically, in a case where the app executing section 60 of the mobile terminal 6a obtains a signal indicating a touch operation carried out on the allow button 84, the app executing section 60 transmits, to the server 1a, a permission notification for giving permission to join the telephonic conversation. In a case where the answering section 106 receives the permission notification, the answering section 106 connects the mobile terminal 6c and the shared call unit 2 in a manner so as to enable telephonic conversation therebetween. The answering section 106 then controls the mobile terminal 6c so that the mobile terminal 6c displays a telephonic conversation screen.

In a case where the app executing section 60 obtains a signal indicating a touch operation carried out on the deny button 85, the app executing section 60 transmits, to the server 1a, a denial notification for denying permission to join the telephonic conversation. In a case where the posting section 105 receives the denial notification, the posting section 105 generates a denial notification message which indicates that the join request was denied. The posting section 105 then supplies the denial notification message to the message board managing section 14. The message board managing section 14 transmits the denial notification message to the mobile terminal 6c. This makes it possible for the mobile terminal 6c to display the denial notification message on the message board screen and provide to Taro a notification indicating that the join request has been denied.

Next, the following description will discuss, with reference to (c) and (d) of FIG. 20, an example in which a resident who is participating in a telephonic conversation invites another resident, who is not participating, to join the telephonic conversation. (c) of FIG. 20 is a diagram illustrating a telephonic conversation screen which is displayed by the mobile terminal 6a belonging to Dad. The telephonic conversation screen includes icons 86 which are displayed in an area of the screen denoted by the text “Invite to join call”. The icons 86 represent Mom and Taro and are UIs which accept an input operation. In a case where Dad wishes to invite another resident (for example, Mom) to the telephonic conversation, Dad inputs, into the mobile terminal 6a, a touch operation carried out on one of the icons 86. In a case where the app executing section 60 obtains a signal indicating the touch operation, the app executing section 60 transmits a join request notification to the server 1a. The join request notification is for adding the mobile terminal 6b (belonging to Mom) to the telephonic conversation between the mobile terminal 6a and the shared call unit 2.

(d) of FIG. 20 is a diagram illustrating an example of a message board screen which is displayed, on the mobile terminal 6b belonging to Mom, after Dad has made the join request. In a case where the posting section 105 receives the join request notification, the posting section 105 generates a visit notification message 71e as illustrated in (d) of FIG. 20. Specifically, the visit notification message 71e differs from the visit notification message 71d of (a) of FIG. 20 in that the visit notification message 71e includes text which reads “Dad is in the middle of a call. Dad has invited you to join the call”, instead of the text reading “Dad is in the middle of a call. You can join by pressing the button below”. The posting section 105 supplies the visit notification message 71e to the message board managing section 14. The message board managing section 14 transmits the visit notification message 71e to the mobile terminal 6b. The app executing section 60 of the mobile terminal 6b then generates a message board screen including the visit notification message 71e and causes the message board screen to be displayed.

In a case where Mom wishes to join the telephonic conversation with the visitor, Mom inputs, into the mobile terminal 6b, a touch operation carried out on the UI 76. In a case where the app executing section 60 obtains a signal indicating the touch operation, the app executing section 60 transmits an acceptance notification to the server 1a. The acceptance notification is for adding the mobile terminal 6b to the telephonic conversation between the mobile terminal 6a and the shared call unit 2. In a case where the answering section 106 receives the acceptance notification, the answering section 106 (i) connects the mobile terminal 6b and the shared call unit 2 in a manner so as to enable telephonic conversation therebetween and (ii) controls the mobile terminal 6b so that the mobile terminal 6b displays a telephonic conversation screen.

(Flow of Notification Processing)

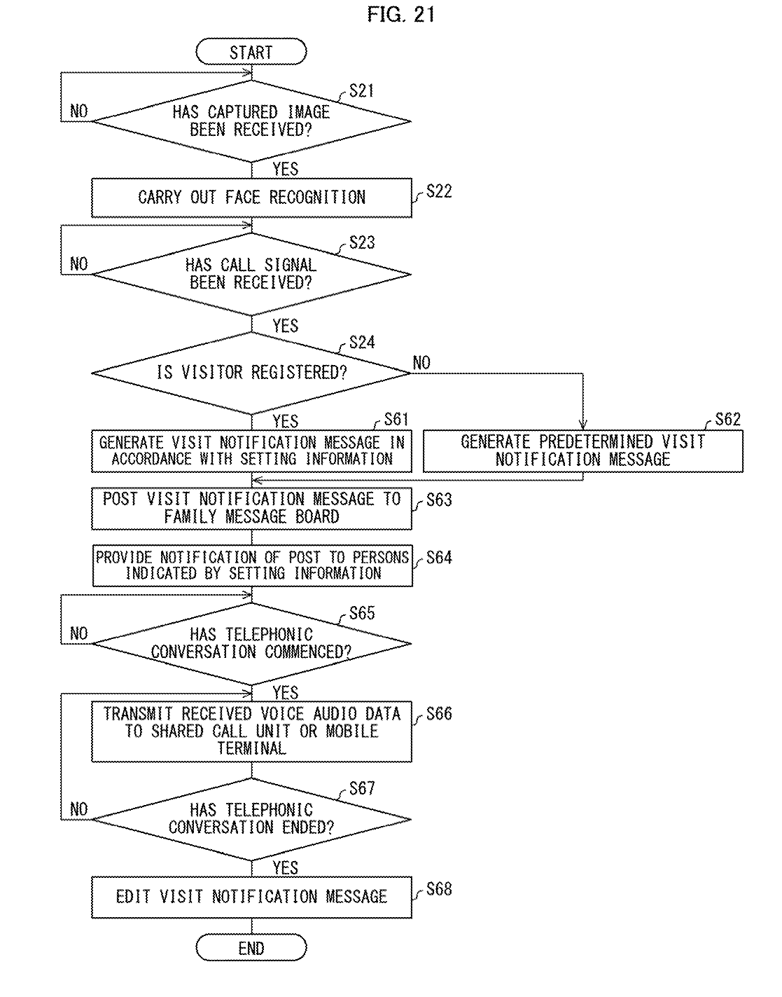

Next, the following description will discuss, with reference to FIG. 21, a flow of notification processing carried out by the server 1a in accordance with the present embodiment. FIG. 21 is a flowchart illustrating an example flow of notification processing. Note that steps which are similar to those of the processing for determining the content of an answer, as described in Embodiment 1 with reference to FIG. 7, are given the same step number as in FIG. 7, and descriptions of such steps are omitted here.

In the case of “YES” in step S24, the face recognition section 102 reads out a piece of the visitor information 191 which represents the visitor and supplies the piece of the visitor information 191 to posting section 105. The posting section 105 then generates a visit notification message in accordance with the setting information included in the piece of the visitor information 191 obtained from the face recognition section 102 (S61). Specifically, the posting section 105 generates a visit notification message which includes a name of the visitor and a symbol which indicates the type of the visitor, each of which is contained in the piece of the visitor information 191.

Conversely, in the case of “NO” in step S24, the face recognition section 102 supplies, to the posting section 105, a notification indicating that a visitor could not be identified. After receiving this notification, the posting section 105 generates a predetermined visit notification message which can be used regardless of the visitor (S62). Specifically, the posting section 105 generates a visit notification message which includes neither a name of the visitor nor a symbol which indicates the type of the visitor.

Next, the posting section 105 supplies the visit notification message thus generated to the message board managing section 14. The message board managing section 14 posts the visit notification message to the family message board (S63). Furthermore, once the posting section 105 supplies the visit notification message to the message board managing section 14, the posting section 105 notifies the notifying section 104 of such. After receiving this notification, the notifying section 104 provides, to the mobile terminal 6, a notification indicating that the visit notification message has been posted (that is, the notifying section 104 carries out post notification) (S64). In doing so, the notifying section 104 carries out the post notification in a manner in accordance with whether or not the notifying section 104 has obtained forwarding address information 903 from the posting section 105, that is, whether or not the visitor is registered. Specifically, in a case where the visitor is registered, the notifying section 104 transmits the post notification to a mobile terminal 6 indicated by a forwarding address having the lowest number among the forwarding addresses in the forwarding address information 903. Conversely, in a case where the visitor is not registered, the notifying section 104 transmits the post notification to mobile terminals 6 of all residents.

Next, once the post notification is transmitted to the mobile terminal 6, the answering section 106 waits for a telephonic conversation to commence (S65). Specifically, the answering section 106 waits for a telephonic-conversation commencement instruction from the mobile terminal 6. In a case where the answering section 106 receives the telephonic-conversation commencement instruction (“YES” in S65), the answering section 106 commences the telephonic conversation between the mobile terminal 6 and the shared call unit 2. In other words, the answering section 106 transmits, to the shared call unit 2, voice audio data received from the mobile terminal 6, and controls the shared call unit 2 so that the shared call unit 2 outputs the voice audio data. The answering section 106 also transmits, to the mobile terminal 6, voice audio data received from the shared call unit 2, and controls the mobile terminal 6 so that the mobile terminal 6 outputs the voice audio data (S66).

While controlling the telephonic conversation, the answering section 106 waits to receive a telephonic-conversation termination instruction (S67). In a case where the answering section 106 receives the telephonic-conversation termination instruction (“YES” in S67), the answering section 106 ends the telephonic conversation between the mobile terminal 6 and the shared call unit 2. In a case where the answering section 106 has received the telephonic-conversation termination instruction (“YES” in S67), the posting section 105 edits the visit notification message such that the user (resident) of each mobile terminal 6 can ascertain that the telephonic conversation has ended (S68). The notification processing then ends.

(Updating of Visitor Information)

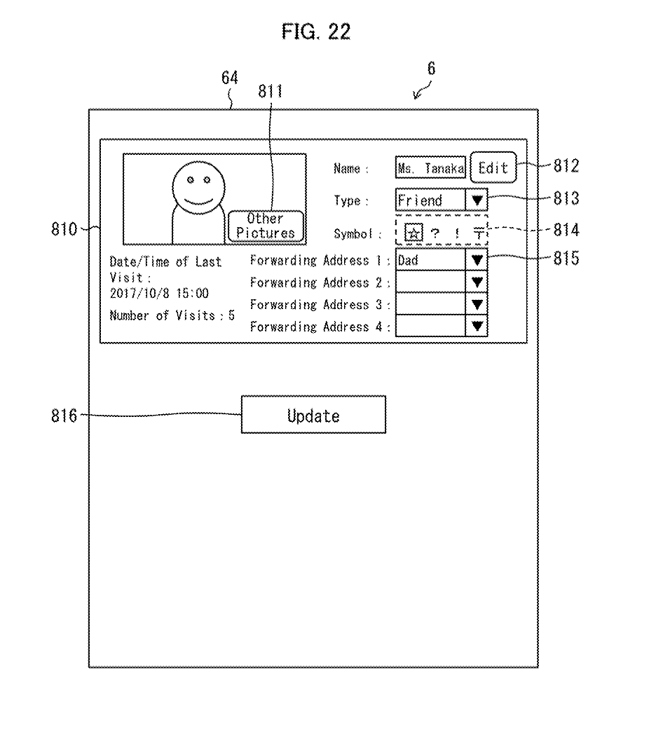

Next, the following description will discuss updating of the visitor information 191 with use of the mobile terminal 6. FIG. 22 is a diagram illustrating an example of an editing area 810 used for editing a piece of the visitor information 191. The editing area 810 is displayed by the mobile terminal 6. Descriptions will be omitted for processing which is similar to that for updating the visitor information 190 as discussed in Embodiment 1.

As described in Embodiment 1, in accordance with an operation by the user (resident), the app executing section 60 controls the display section 64 so that the display section 64 displays a list of the visitor information 191. Specifically, the list is of pieces of the visitor information 191 that are associated with a monitor ID indicating the residence at the which resident resides. This list is displayed as a screen in which the face images are listed. For example, the display section 64 is controlled to display a plurality of pieces of the visitor information 191, which pieces are stored in the column for “IPAA0405” shown in FIG. 17. In a case where the operation section 63 accepts a touch operation carried out on any one of the plurality of pieces of the visitor information 191, the app executing section 60 controls the display section 64 so that the display section 64 displays a setting screen. The setting screen includes the editing area 810 for editing the piece of the visitor information 191 which the user has selected.

As illustrated in FIG. 22, the editing area 810 includes UIs which are capable of accepting an operation (edit operation) inputted by the user for editing the visitor information. A UI 811 is for accepting an edit operation for changing a face image 901 included in a piece of the visitor information 191 to another face image 901 which has the same facial characteristics. In a case where the app executing section 60 obtains, from the operation section 63, a signal (edit signal) indicating that the operation section 63 has accepted a touch operation carried out on the UI 811, the app executing section 60 receives, from the server 1a, a plurality of face images having the same facial characteristics. The app executing section 60 then controls the display section 64 so that the display section 64 displays the plurality of face images. The plurality of face images are images which have been previously generated by the output control section 101a and which are stored by the storage section 11a (though this is not illustrated in FIG. 15). Each of the plurality of face images stored is associated with information (visitor identifying information) which enables identification of a visitor. The app executing section 60 transmits, to the server 1a, the visitor identifying information for the visitor shown in the editing area 810. This allows the server 1a to then select face images having the same facial characteristics as the face image 901 of the visitor shown in the editing area 810.

In a case where the app executing section 60 obtains, from the operation section 63, a signal indicating that the operation section 63 has accepted an operation to select one of the face images from among the plurality of face images being displayed, the app executing section 60 replaces the face image 901 with the face image that has been selected.

This configuration, which allows the face image 901 to be changed, brings about advantages such as the following. For a piece of the visitor information 191 in which a name is not registered, if the face image 901 is not clear, the user of the mobile terminal 6 may not be able to determine who the visitor is (may not be able to input a name). In such a case, allowing the user to select the face image 901 from among a plurality of face images having the same facial characteristics makes it possible for the user to select a clearer image. Furthermore, this makes it possible for the user to easily determine who the visitor is and input a name of the visitor.

A UI 812 is for accepting an edit operation for changing the name of the visitor. In a case where the app executing section 60 obtains, from the operation section 63, a signal indicating that the operation section 63 has accepted a touch operation carried out on the UI 812, the app executing section 60 takes on a state in which input of a name is accepted. After a user carries out an input operation to input a name into the operation section 63, the operation section 63 supplies, to the app executing section 60, a signal including an inputted text string. The app executing section 60 then carries out control so that the inputted text string is displayed in a box (in the illustrated example, the rectangular area containing the text “Ms. Tanaka”).

A UI 813 is for accepting an edit operation for changing the type of the visitor. In a case where the app executing section 60 obtains, from the operation section 63, a signal indicating that the operation section 63 has accepted a touch operation carried out on the UI 813, the app executing section 60 controls the display section 64 so that the display section 64 displays options for a type to be selected. In addition to the type “Friend” shown in the drawing, examples of options for the type to be selected include “family,” “delivery worker,” “postal worker,” “solicitor,” and “suspicious person”. In a case where the app executing section 60 obtains, from the operation section 63, a signal indicating that the operation section 63 has accepted a touch operation carried out on one of the options, the app executing section 60 changes the type to the type which has been selected. The options include a blank which can be selected in order to delete the current type.

A UI 814 is for accepting an edit operation for changing a symbol indicating a type. In a case where the app executing section 60 obtains, from the operation section 63, a signal indicating that the operation section 63 has accepted a touch operation carried out on the UI 814 (that is, a touch operation carried out on any symbol), the app executing section 60 changes the displayed screen in a manner which indicates that the symbol that was touched has been selected. In the illustrated example, this is accomplished by displaying a square surrounding the selected symbol.

A UI 815 is for accepting an edit operation for changing forwarding address information. In a case where the app executing section 60 obtains, from the operation section 63, a signal indicating that the operation section 63 has accepted a touch operation carried out on the UI 815, the app executing section 60 controls the display section 64 so that the display section 64 displays options for a forwarding address to be selected. Options for the forwarding address to be selected are (i) the members of the family message board and (ii) a blank. The app executing section 60 obtains, from the server 1a, a list of the members of the family message board to which the user of the mobile terminal 6 belongs. The app executing section 60 then controls the display section 64 so that the display section 64 displays this list as options for the forwarding address to be selected. In the present embodiment, in a case where the app executing section 60 obtains, from the operation section 63, a signal indicating that the operation section 63 has accepted a touch operation carried out on one of the options (which are “Dad,” “Mom,” “Taro,” and a blank), the app executing section 60 changes the forwarding address to the forwarding address which has been selected. Note that selecting a blank deletes the current forwarding address information. Note also that is it possible to select a plurality of forwarding addresses. There may be a plurality of UIs 815, as illustrated.

An update button 816 is a UI for providing an instruction to update the visitor information 191. In a case where the app executing section 60 obtains, from the operation section 63, a signal indicating that the operation section 63 has accepted a touch operation carried out on the update button 816, the app executing section 60 transmits the visitor information 191 which has been changed to the server 1a. The DB updating section 103 updates the visitor information 191 by storing, in the face image DB 111a, the visitor information 191 which has been received.

### Embodiment 4

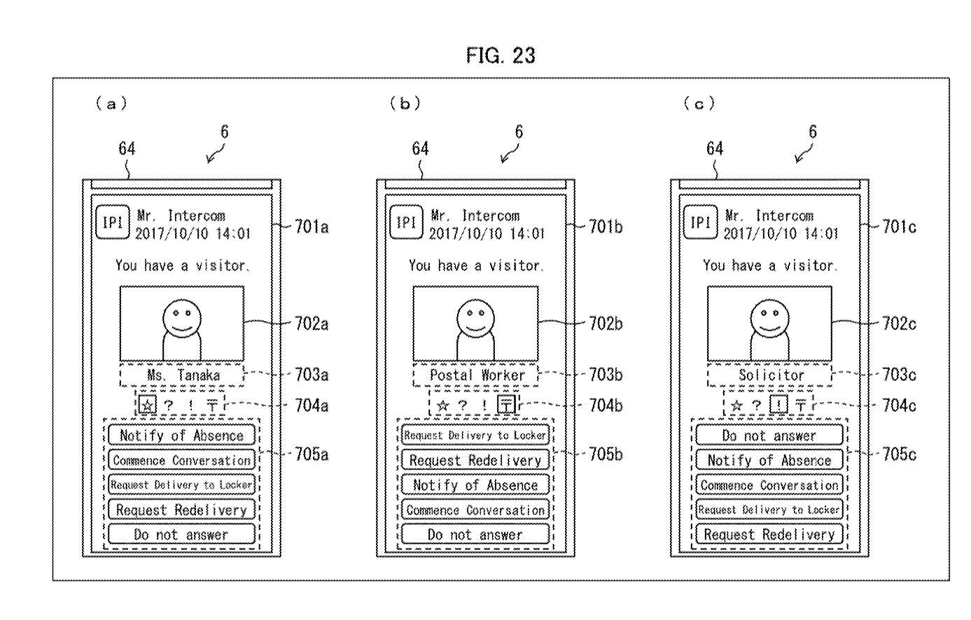

The following description will discuss, with reference to FIGS. 23 to 26, yet another embodiment in accordance with the present invention. For convenience, members similar in function to those described in the foregoing embodiment(s) will be given the same reference signs, and their description will be omitted.

FIG. 23 is a diagram illustrating examples of a message board screen displayed on a mobile terminal 6, in accordance with the present embodiment. The message board screen illustrated in FIG. 23 includes a visit notification message 701 (a term collectively referring to visit notification messages 701a through 701c illustrated in FIG. 23) in accordance with the present embodiment.

The visit notification message 701 differs from the visit notification message described in Embodiment 3 in that the visit notification message 701 includes a plurality of UIs 705 relating to responses to a visitor. In other words, a user (resident) of a mobile terminal 6 in accordance with the present embodiment is able to respond to the visitor in a manner other than commencing a telephonic conversation.

The order of the plurality of UIs 705 is decided in accordance with the visitor. Illustrated in (a) of FIG. 23 is the visit notification message 701a, which indicates that “Ms. Tanaka” who is a friend, is making a visit. In the visit notification message 701a, the following UIs are arranged in the following order, from top to bottom: a UI for “Notify of absence”; a UI for “Commence conversation”; a UI for “Request delivery to locker”; a UI for “Request redelivery”; and a UI for “Do not answer”. The UI for “Notify of absence” is for carrying out an automatic answer which indicates that the resident is not home. The UI for “Commence conversation” is for commencing a telephonic conversation. The UI for “Request delivery to locker” for carrying out an automatic answer to request that a parcel be put into a parcel storage locker. The UI for “Request redelivery” is for carrying out an automatic answer to request that a parcel be redelivered. The UI for “Do not answer” for not responding. The UIs are ordered such that a UI for a response which has a high likelihood of being selected is positioned higher up.

Note that the UI for “Request delivery to locker” and the UI for “Request redelivery” are each a UI that can be used in a response to a postal worker or a delivery worker. It is not necessary for the visit notification message 701a to include these UIs. However, depending on the accuracy of face recognition carried out by the server 1a, there is a possibility of a situation in which, for example, (i) a postal worker or delivery worker is erroneously recognized as being a friend, or (ii) the result of the face recognition shows that there is a high possibility that the visitor is a friend, but there is also a possibility that the visitor is a postal worker or a delivery worker. In order to account for cases such as these, it is preferable to include, in the visit notification message 701a, the UI for “Request delivery to locker” and the UI for “Request redelivery”.

Illustrated in (b) of FIG. 23 is the visit notification message 701b, which indicates that a postal worker is making a visit. In the visit notification message 701b, the UIs are arranged in the following order, from top to bottom: the UI for “Request delivery to locker”; the UI for “Request redelivery”; the UI for “Notify of absence”; the UI for “Commence conversation”; and the UI for “Do not answer”. Illustrated in (c) of FIG. 23 is the visit notification message 701c, which indicates that a solicitor is making a visit. In the visit notification message 701c, the UIs are arranged in the following order, from top to bottom: the UI for “Do not answer”; the UI for “Notify of absence”; the UI for “Commence conversation”; the UI for “Request delivery to locker”; and the UI for “Request redelivery”. In this way, the UIs are displayed in a different order in accordance with the visitor. Note that the types of UIs illustrated in FIG. 23 are merely examples. The UIs are not limited to the five types illustrated.

A posting section 105 in accordance with the present embodiment differs from the posting section 105 described in Embodiment 3 in that, in the present embodiment, the posting section 105 reads out a plurality of UIs 705 from visit notification post data 113 and arranges the plurality of UIs 705 in an order in accordance with a piece of visitor information 191 obtained from a face recognition section 102. Specifically, the posting section 105 determines a priority level of each of the plurality of UIs 705 based on the piece of the visitor information 191 which has been obtained. The posting section 105 then arranges each of the plurality of UIs 705 in order of highest priority level to lowest priority level. Arranging UIs of a higher priority level so as to be positioned higher up makes it possible to increase the conspicuousness of options which are likely to be selected. Note that the processing which is carried out by the posting section 105 in accordance with the priority level that has been decided is not limited to changing the order of the options. The posting section 105 need only generate a visit notification message in which the options that are likely to be selected are more conspicuous. For example, options having a high priority level may be changed by changing the color of text or the color of the background, by changing the size of text, or by changing the size of the UI itself. In a case where the posting section 105 has received, from the face recognition section 102, a notification indicating that a piece of the visitor information 191 could not be identified, the posting section 105 may arrange the plurality of UIs 705 in a predetermined order.

An answering section 106 in accordance with the present embodiment differs from the answering section 106 described in Embodiment 3 in the following manner. In the present embodiment, in a case where the answering section 106 receives, from the mobile terminal 6, an instruction (automatic answer instruction) to control a shared call unit 2 so that the shared call unit 2 carries out an automatic answer, the answering section 106 reads out, from among the voice audio data 112, a piece of voice audio data in accordance with the instruction, and transmits the piece of the voice audio data to the shared call unit 2. The automatic answer instruction is transmitted from the mobile terminal 6 in accordance with a touch operation carried out on any one of the UI for “Request delivery to locker”, the UI for “Request redelivery”, and the UI for “Notify of absence”. For example, in a case where the answering section 106 has received an automatic answer instruction for carrying out notification of absence, the answering section 106 reads out voice audio data for the phrase “Sorry to miss you, but I'm out at the moment”, and transmits the voice audio data to the shared call unit 2. The shared call unit 2 outputs the voice audio data received and thus an automatic answer is carried out. Note that in the following descriptions, both of the terms “automatic answer instruction” and “telephonic-conversation commencement instruction” may be referred to collectively as “answer instruction”.

(Informing Visitor of Planned Time of Return)

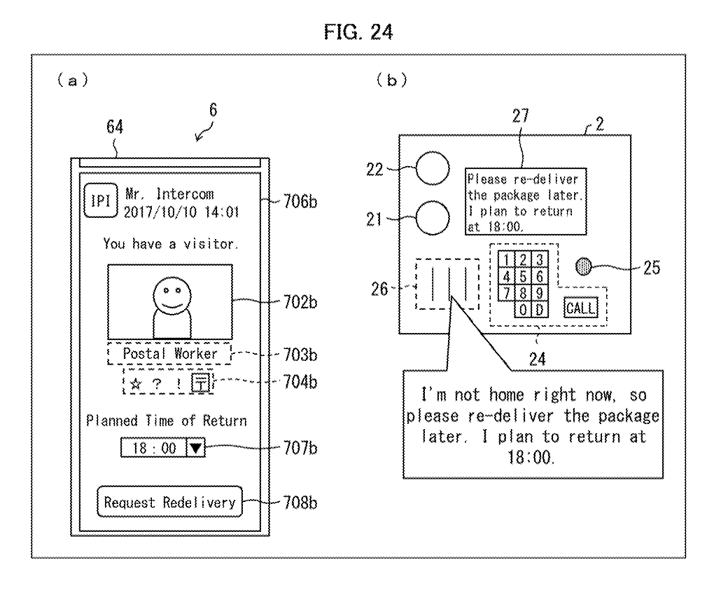

FIG. 24 is a diagram illustrating an example of how a visitor can be informed of a planned time of return. In a case where a touch operation has been carried out on the UI for “Request redelivery” or the UI for “Notify of absence” in the visit notification message 701, a visit notification message 706 may be displayed instead of the visit notification message 701. (a) of FIG. 24 is a diagram illustrating an example where a visit notification message 706b is displayed after a touch operation was carried out on the UI for “Request redelivery” in the visit notification message 701b (see (b) of FIG. 23).

In a case where the posting section 105 receives, from the mobile terminal 6, information indicating that a touch operation has been carried out on the UI for “Request redelivery” or the UI for “Notify of absence,” the posting section 105 generates the visit notification message 706 and supplies the visit notification message 706 to a message board managing section 14. The visit notification message 701 is then changed to the visit notification message 706.

As illustrated in (a) of FIG. 24, the visit notification message 706b includes a UI 707b and a UI 708b. The UI 707b is for accepting an input operation for inputting a planned time of return. In a case where an app executing section 60 obtains, from the operation section 63, a signal indicating that the operation section 63 has accepted a touch operation carried out on the UI 707b, the app executing section 60 controls a display section 64 so that the display section 64 displays options for a planned time of return to be selected. In the example illustrated, 18:00 has been selected. Note that the options may include an option reading “Do not notify,” which indicates that the visitor will not be notified of a planned time of return. Instead of providing options for a planned time of return to be selected, the UI 707b may accept input of text which indicates the planned time of return.

The UI 708b is for transmitting an automatic answer instruction to the server 1a. In a case where the app executing section 60 obtains, from the operation section 63, a signal indicating that the operation section 63 has accepted a touch operation carried out on the UI 708b, the app executing section 60 transmits, to the server 1a, the automatic answer instruction and time information indicating the planned time of return. In the example illustrated in (a) of FIG. 24, the app executing section 60 will transmit, to the server 1a, an automatic answer instruction for carrying out an automatic answer to request redelivery and time information indicating 18:00.

In a case where the answering section 106 receives the automatic answer instruction and the time information, the answering section 106 adds a notification of the planned time of return to the voice audio data for the automatic answer and then transmits the voice audio data to the shared call unit 2. (b) of FIG. 24 is a diagram illustrating an example of an automatic answer carried out by the shared call unit 2. The automatic answer illustrated in (b) of FIG. 24 an example in which the mobile terminal 6 has transmitted, to the server 1a, an automatic answer instruction indicating the content shown in (a) of FIG. 24.

Specifically, from among the voice audio data 112, the answering section 106 reads out, as voice audio data for the automatic answer, a piece of voice audio data for the phrase, “I'm not home right now, so please re-deliver the package later. I plan to return at [time].” For the “[time]” in this voice audio data, the answering section 106 adds voice audio data based on the time information (in the example of (b) of FIG. 24, voice audio data for “18:00”). The answering section 106 then transmits this voice audio data to the shared call unit 2. In this way, it is possible for the shared call unit 2 to output voice audio for the phrase, “I'm not home right now, so please re-deliver the package later. I plan to return at 18:00.”

(Notification Indicating that Response has Finished)

As described in Embodiment 3, once a response has finished, the content of the visit notification message is changed to indicate such. Discussed in Embodiment 3 was an example in which the visit notification message is changed to the visit notification message 71c. As illustrated in (c) of FIG. 18, the visit notification message 71c includes text reading “Call taken via smartphone” and “Response handled by: Dad” instead of the text 73, the symbols 74, and the UI 75. Furthermore, text indicating the date/time at which the telephonic conversation ended is added. This is an example of a change carried out in a case where Dad carried out a telephonic conversation with the visitor by using the mobile terminal 6a.

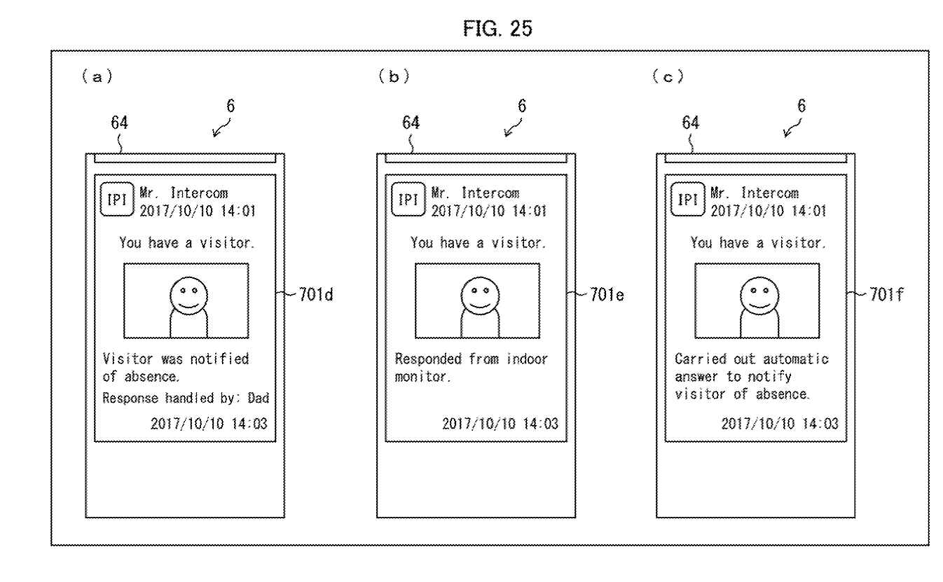

In the present embodiment, in a case where a resident has selected a method of responding other than a telephonic conversation with the visitor, i.e., in a case where a resident has selected, out of the plurality of UIs 705, a UI other than the UI for “Commence conversation”, the visit notification message to be displayed after the response is finished is changed in accordance with the UI that was selected. FIG. 25 is a diagram illustrating variations of the visit notification message to be displayed after a response is finished. For example, in a case where the UI for “Notify of absence” was selected from among the plurality of UIs 705 and the shared call unit 2 has accordingly outputted voice audio in an automatic answer for notifying the visitor of the resident's absence, the mobile terminal 6 displays a visit notification message 701d as illustrated in (a) of FIG. 25.

The visit notification message 701d includes (i) text reading, “Visitor was notified of absence”, (ii) text reading, “Response handled by: Dad”, and (ii) text indicating the date/time of the response. This text takes the place of text 703, symbols 704, and the plurality of UIs 705. More specifically, in a case where the answering section 106 has transmitted voice audio data for an automatic answer to the shared call unit 2, the posting section 105 generates the visit notification message 701d by (i) deleting, from the visit notification message 701 (for example, the visit notification message 701a illustrated in FIG. 23), the text 703, the symbols 704, and the plurality of UIs 705, and (ii) adding, in place of the deleted elements, the text reading “Visitor was notified of absence”, the text reading “Response handled by: Dad”, and the text indicating the date/time of the response (i.e., the date/time at which the voice audio data for the automatic answer was transmitted to the shared call unit 2). The posting section 105 then supplies the visit notification message 701d to the message board managing section 14 and controls the message board managing section 14 so that the message board managing section 14 replaces the visit notification message 701a with the visit notification message 701d. The message board managing section 14 then transmits, to the mobile terminal 6, a display screen in which the visit notification message has been replaced thusly. In this way, the mobile terminal 6 is controlled to display the display screen illustrated in (a) of FIG. 25. This makes it possible for a resident other than Dad to ascertain that Dad responded to the visitor by selecting “Notify of absence”.

In a case where an automatic answer other than notification of absence has been carried out, the visit notification message 701 includes text in accordance with that automatic answer. For example, in a case where an automatic answer to request redelivery was carried out, text reading “Redelivery requested” is added. In a case where the UI for “Do not answer” was selected, for example, only text reading “No response made” is added, and there is no text is added to indicate the name of a person who responded or the date/time of the response.

In a case where a response is made without use of the mobile terminal 6, the visit notification message 701 may be changed in a manner differing from that described above. For example, in a case where a resident inside the residence has responded with use of the indoor monitor 3, the mobile terminal 6 displays a visit notification message 701e as illustrated in (b) of FIG. 25.

The visit notification message 701e includes text reading “Responded from indoor monitor” and text indicating the date/time of the response, instead of the text 703, the symbols 704, and the plurality of UIs 705. Note that in this example, because the person who responded cannot be identified, text indicating the name of the person who responded is not added.

Specifically, in a case where a response is carried out with use of the indoor monitor 3 in accordance with the present embodiment (for example, in a case where an operation is inputted into an operation section 34 or a case where voice audio is inputted into a voice audio input section 35), the indoor monitor 3 notifies the server 1a of such. In a case where the posting section 105 receives such a notification, the posting section 105 generates the visit notification message 701e by (i) deleting, from the visit notification message 701 (for example, the visit notification message 701a illustrated in FIG. 23) the text 703, the symbols 704, and the plurality of UIs 705, and (ii) adding, in place of the deleted elements, the text reading “Responded from indoor monitor” and text indicating the date/time of the response (i.e., the date/time at which the notification was received from the indoor monitor 3). Processing carried out thereafter is similar to that described for the case of the visit notification message 701d, and a description of such is therefore omitted here.

The answering section 106 of the server 1a may be configured to carry out a predetermined automatic answer (for example, an automatic answer for notification of absence) in a case where (i) an elapsed amount of time, starting from when the shared call unit 2 transmitted the call signal, has passed a predetermined threshold and (ii) no response was carried out with the indoor monitor 3 or the mobile terminal 6. In a case where the predetermined automatic answer has been carried out, the mobile terminal 6 displays a visit notification message 701f as illustrated in (c) of FIG. 25.

The visit notification message 701f includes text reading “Carried out automatic answer to notify visitor of absence” and text indicating the date/time of the response, instead of the text 703, the symbols 704, and the plurality of UIs 705. More specifically, in a case where the posting section 105 has received an automatic-answer-data request (see Embodiment 1) from the shared call unit 2, the posting section 105 generates the visit notification message 701f by (i) deleting, from the visit notification message 701 (for example, the visit notification message 701a illustrated in FIG. 23), the text 703, the symbols 704, and the plurality of UIs 705, and (ii) adding, in place of the deleted elements, the text reading “Carried out automatic answer to notify visitor of absence” and text indicating the date/time of the response (i.e., the date/time at which the automatic-answer-data request was received). Processing carried out thereafter is similar to that described for the case of the visit notification message 701d, and a description of such is therefore omitted here.

Discussed above are examples in which the visit notification message 701a is replaced by a message providing notification that an answer has finished, such as the visit notification message 71c or one of the visit notification messages 701d through 701f. Alternatively, the message to provide notification that an answer has finished may be posted to the family message board as a new message that differs from the visit notification message 701a. In other words, the message to provide notification that an answer has finished need only be displayed on the family message board.

(Flow of Notification Processing)

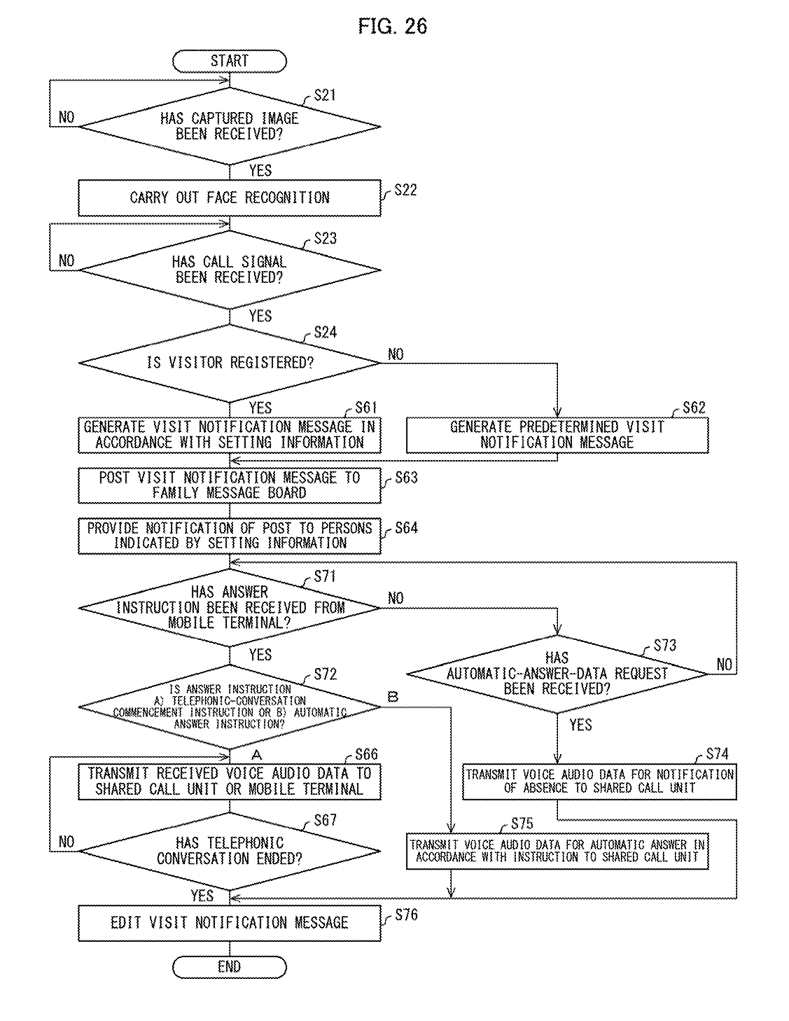

Next, the following description will discuss, with reference to FIG. 26, a flow of notification processing carried out by the server 1a in accordance with the present embodiment. FIG. 26 is a flowchart illustrating an example flow of notification processing. Note that steps which are similar to those of the notification processing as described in Embodiment 3 with reference to FIG. 21 are given the same step number as in FIG. 21, and descriptions of such steps are omitted here.

In a case where a post notification is transmitted to the mobile terminal 6 in step S63, the answering section 106 waits for an answer instruction from the mobile terminal 6 (S71). In a case where the answering section 106 receives the answer instruction (“YES” in S71), the answering section 106 determines whether the answer instruction is a telephonic-conversation commencement instruction or an automatic answer instruction (S72). In a case where the answer instruction is an telephonic-conversation commencement instruction (“A” in S72), the answering section 106 carries out the processing of steps S66 and S67.

Conversely, in a case where the answer instruction is an automatic answer instruction (“B” in S72), the answering section 106 transmits, to the shared call unit 2, voice audio data for an automatic answer in accordance with the instruction (S75).

In a case where (i) the answering section 106 does not receive an answer instruction from the mobile terminal in step S71 (“NO” in S71) and (ii) the answering section 106 has received an automatic-answer-data request from the shared call unit 2 (“YES” in S73), the answering section 106 transmits, to the shared call unit 2, voice audio data for a notification of absence (S74). The example in which the voice audio data transmitted in step S74 is voice audio data for notification of absence is just one example.

Finally, the posting section 105 edits the visit notification message in accordance with the content of the response (S76). The notification processing then ends.

(Variations Applicable to Both Embodiment 3 and Embodiment 4)

The indoor monitor 3 may be configured to have a function of storing and executing the family message board app 611. In other words, the indoor monitor 3 may include members similar to those of the app executing section 60 of the mobile terminal 6.

Furthermore, the application used for carrying out a response to the visitor with use of the mobile terminal 6 is not limited to being the family message board app 611. For example, the application may have only (i) a function of providing a notification indicating that a visitor is making a visit and (ii) a function which enables a response to the visitor (for example, a telephonic conversation function and an automatic answer function), without having an electronic message board function.

The visitor information 191 may include “cannot respond” information which indicates that a resident cannot respond to a visitor with use of the mobile terminal 6. The “cannot respond” information is set with use of a mobile terminal 6 belonging to a resident. In this example configuration, in a case where the piece of the visitor information 191 which has been identified contains the “cannot respond” information, the posting section 105 further generates a visit notification message which does not include, for example, the UI 75 for commencing a telephonic conversation with the visitor, or the plurality of UIs 705 relating to responding to the visitor. The posting section 105 then supplies this visit notification message, along with the “cannot respond” information, to the message board managing section 14. The message board managing section adds the visit notification message (which contains neither the UI 75 nor the plurality of UIs 705) to the post display data to be transmitted to the mobile terminal 6 belonging to the resident indicated by the “cannot respond” information thus obtained. The message board managing section 14 then transmits the post display data to that mobile terminal 6. In this way, it is possible to prevent a specific resident from responding to a visitor that he/she should not respond to. For example, it is possible to prevent Taro (a child) from being able to use the mobile terminal 6c to respond to a solicitor. This makes it possible to improve safety.

The server 1a may be configured to control the shared call unit 2 so that the shared call unit 2 carries out an automatic answer without providing notification to a mobile terminal 6, depending on the visitor. Specifically, in a case where the piece of the visitor information 191 that has been identified contains a flag indicating that an automatic answer should be carried out, the posting section 105 may notify the answering section 106 of such and control the answering section 106 so that the answering section 106 carries out an automatic answer in accordance with the piece of the visitor information 191. The flag can be set by updating the visitor information 191 with use of the mobile terminal 6. This configuration makes it possible, for example, in a case where the visitor is a delivery worker, for the server 1a to control the shared call unit 2 so that the shared call unit 2 carries out an automatic answer to request a delivery to a parcel storage locker, without a user operation to select the content of the answer.

[Variations Applicable to Each Embodiment]

The shared call unit 2 may store voice audio data for automatic answers. Similarly, the indoor monitor 3 may store notification voice audio data. In such configurations, the server 1 (or the server 1a) is configured to (i) identify information for specifying voice audio data and (ii) transmit the information to the shared call unit 2 or the indoor monitor 3. The shared call unit 2 and the indoor monitor 3 then use the information received from the server 1 (or server 1a) to identify the voice audio data to be outputted as voice audio.

Discussed in Embodiments 1 to 4 were examples in which the output control device in accordance with an embodiment of the present invention was utilized in the server 1 (or the server 1a). Note, however, that the output control device may be utilized in the shared call unit 2, the intercom control device 4, or the apartment building controller 5.

Furthermore, the server 1 (or the server 1a) may control the shared call unit 2 so that the shared call unit 2 obtains, in addition to the captured image, identification information which the visitor has. The captured image and the identification information may then both be used to identify the visitor. Examples of the identification information include, but are not limited to, an ID of a terminal device (mobile terminal, electronic money card, etc.) owned by the visitor. In such a configuration, the visitor information 190 (or the visitor information 191) includes the identification information, and the face recognition section 102 uses (i) the result of face recognition and (ii) the identification information to identify visitor information.

Furthermore, in the Embodiments 1 to 4, the server 1 (or the server 1a) is configured so as to carry out processing such as automatic answers, call actions, post notifications, and determining the order of options for answering in accordance with setting information that was identified based on the result of face recognition. In other words, the server 1 (or the server 1a) is configured to always carry out output in accordance with settings carried out by the user. The server 1 (or the server 1a) is not, however, limited to always carrying out output in accordance with the settings carried out by the user. For example, the server 1 (or the server 1a) may store an output history in which (i) face images of visitors are associated with (ii) information indicating output carried out in the past. In such a case, the server 1 (or the server 1a) may be configured such that, in a case where after the face recognition, it is identified from the output history that the visitor has made a visit before, the server 1 (or the server 1a) carries out output associated with the person (face image) who has been identified.

The shared call unit 2 may be configured so as not to include the human sensor 22. In such a configuration, the shared call unit 2 is configured so that the image capturing section 21 is controlled so as to commence image capture in a case where a call operation has been inputted into the operation section 24.

Discussed in Embodiments 1 to 4 were examples in which the intercom system 100 and the intercom system 200 were utilized for an apartment building. Note, however, that the intercom system 100 and the intercom system 200 may be utilized for a stand-alone house. In such a configuration, the shared call unit 2 is embodied as front door slave unit.

The intercom system 100 and the intercom system 200 may each include, in addition to (or instead of) the mobile terminal 6, a terminal device which is not designed to be portable, such as a personal computer or a television. In such a configuration, the terminal device has functions similar to those of the mobile terminal 6 as described in Embodiments 1 to 4.

### Embodiment 5

Discussed in the preceding embodiments were examples which each utilized one server 1 (or one server 1a). However, it is possible to use separate servers to realize each function of the server 1 (or the server 1a). In a case where a plurality of servers is employed, each server may be managed by the same operator or by differing operators.

### Embodiment 6

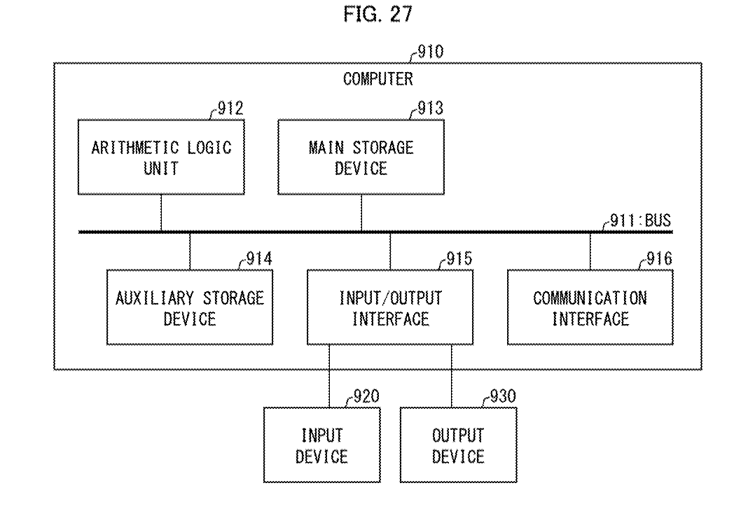

Functional blocks of the server 1 (or the server 1a), the shared call unit 2, the indoor monitor 3, and the mobile terminal 6 can be realized by a logic circuit (hardware) provided in an integrated circuit (IC chip) or the like or can be alternatively realized by software. In the latter case, the server 1 (or the server 1a), the shared call unit 2, the indoor monitor 3, and the mobile terminal 6 can each be realized by a computer (electronic computer) such as that illustrated in FIG. 27.

FIG. 27 is a block diagram illustrating a configuration of a computer 910 by which the server 1 (or the server 1a), the shared call unit 2, the indoor monitor 3, and the mobile terminal 6 can be realized. The computer 910 includes (i) an arithmetic logic unit 912, (ii) a main storage device 913, (iii) an auxiliary storage device 914, (iv) an input/output interface 915, and (v) a communication interface 916 that are connected to each other via a bus 911. The arithmetic logic unit 912, the main storage device 913, and the auxiliary storage device 914 can be realized by, for example, a processor (such as a central processing unit (CPU)), random access memory (RAM), and a hard disk drive, respectively. The input/output interface 915 is connected with (i) an input device 920 via which a user inputs various information into the computer 910 and (ii) an output device 930 via which the computer 910 outputs various information to the user. Each of the input device 920 and the output device 930 can be embedded in the computer 910 or can be alternatively connected to the computer 910 (externally connected to the computer 910). For example, the input device 920 can be a keyboard, a mouse, a touch sensor, or the like, and the output device 930 can be a display, a printer, a speaker, or the like. Alternatively, a device having both of a function of the input device 920 and a function of the output device 930 (such as a touch panel into which a touch sensor and a display are integrated) can be employed. The communication interface 916 is an interface via which the computer 910 communicates with an external device.

The auxiliary storage device 914 stores various programs for causing the computer 910 to operate as the server 1 (or the server 1a), the shared call unit 2, the indoor monitor 3, and the mobile terminal 6. The arithmetic logic unit 912 causes the computer 910 to operate as sections included in the server 1 (or the server 1a), the shared call unit 2, the indoor monitor 3, and the mobile terminal 6 by (i) loading, onto the main storage device 913, the programs stored in the auxiliary storage device 914 and (ii) executing instructions included in the programs. Note that a recording medium which is included in the auxiliary storage device 914 for recording information, such as the various programs, only needs to be a computer-readable “non-transitory tangible medium.” Examples of the recording medium include tapes, disks, cards, semiconductor memories, and programmable logic circuits. The main storage device 913 may be omitted in a case where the computer is capable of executing programs stored on a recording medium without loading the programs onto the main storage device 913. Each of the above devices (the arithmetic logic unit 912, the main storage device 913, the auxiliary storage device 914, the input/output interface 915, the communication interface 916, the input device 920, and the output device 930) may be singular or plural in number.

The various programs can be obtained from outside of the computer 910. In such a case, the various programs can be obtained via any transmission medium (such as a communication network or a broadcast wave). The present invention can also be achieved in the form of a computer data signal in which the various programs are embodied via electronic transmission and which is embedded in a carrier wave.

[Recap]

An output control device (server 1, server 1a) in accordance with Aspect 1 of the present invention is an output control device which controls output relating to a call, the call being made in accordance with a call operation inputted by a visitor into an intercom slave unit (shared call unit 2) having a function of enabling a call to and a telephonic conversation with a resident, the output control device including: a face recognition section (face recognition section 102) configured to carry out face recognition of the visitor based on a captured image obtained from the intercom slave unit; and an output control section (output control section 101, output control section 101a) which carries out control so that the output is carried out, in accordance with a result of the face recognition carried out by the face recognition section, by at least one of (i) the intercom slave unit, (ii) an intercom master unit (indoor monitor 3) having an answer function of enabling answering the call and carrying out a telephonic conversation with the visitor, and (iii) a telephonic conversation device (mobile terminal 6) which differs from the intercom master unit but has the answer function.

With the above configuration, at least one of the intercom slave unit, the intercom master unit and the telephonic conversation device carries out the output in accordance with the result of face recognition. This makes it possible to appropriately identify a visitor and respond in a manner considered appropriate by the resident.

For example, by causing the intercom slave unit to output voice audio for an answer in accordance with the result of the face recognition, it is possible to respond in a manner considered appropriate by the resident without troubling the resident. As another example, by causing the intercom master unit or the telephonic conversation device to output a notification in accordance with the result of the face recognition, it is possible for the resident to ascertain what sort of person a visitor is before conversing with the visitor.

In Aspect 2 of the present invention, the output control device (server 1a) in accordance with Aspect 1 may be arranged such that: the telephonic conversation device (mobile terminal 6) is a mobile terminal which has been registered in the output control device; and the output control section (output control section 101a) controls the mobile terminal so that the mobile terminal provides a notification in accordance with the result of the face recognition, which notification indicates that the call operation was carried out.

With the above configuration, the mobile terminal which has been registered in the output control device is controlled so as to provide notification, in accordance with the result of the face recognition, which notification indicates that the call operation has been carried out. This makes it possible for a user of the mobile terminal to ascertain what sort of person a visitor is before conversing with the visitor. Examples of the user of the mobile terminal registered in the output control device include a resident. In a case where the user is a resident, the resident is able to ascertain that a visitor is making a visit, even if the resident is not at home.

In Aspect 3 of the present invention, the output control device in accordance with Aspect 2 may be arranged such that: the output control section controls the mobile terminal so that the mobile terminal displays, in accordance with the result of the face recognition, options for how to answer the call; and the output control section controls the intercom slave unit so that the intercom slave unit carries out, in response to the call, whichever answer is selected by the resident from among the options.

With the above configuration, the mobile terminal is controlled so as to display options for how to answer, and the intercom slave unit is controlled so as to carry out an answer which is selected by the resident from among the options. This makes it possible for the resident to carry out an appropriate response to the visitor without conversing with the visitor.

In Aspect 4 of the present invention, the output control device in accordance with Aspect 3 may be arranged such that the output control section is configured to (i) determine a priority level of each of the options in accordance with the result of the face recognition and (ii) control the mobile terminal so that the mobile terminal displays the options in accordance with the priority levels thus determined.

With the above configuration, the options for how to answer are displayed in accordance with their priority levels, which are determined in accordance with the result of the face recognition. This makes it possible for the resident to easily select an appropriate method of responding. Examples of displaying the options in accordance with their priority levels include arranging the options so that an option having a higher priority level is displayed at a higher position.

In Aspect 5 of the present invention, the output control device according to any one of Aspects 1 to 4 may be arranged such that: the output control section controls the intercom slave unit so that the intercom slave unit carries out, as an answer in response to the call, an automatic answer in accordance with the result of the face recognition.

With the above configuration, the intercom slave unit is controlled so as to output voice audio for an automatic answer in accordance with the result of the face recognition. This makes it possible to respond in a manner considered appropriate by the resident without troubling the resident.

In Aspect 6 of the present invention, the output control device according to Aspect 5 may be arranged such that: the output control section controls the intercom slave unit so that the intercom slave unit carries out the automatic answer in a case where (i) a predetermined amount of time has elapsed since the call operation was carried out and (ii) during the predetermined amount of time, no answer was carried out with use of the intercom master unit or the telephonic conversation device by the resident in response to the call.

With the above configuration, the intercom slave unit is controlled so as to carry out the automatic answer in a case where the resident does not respond to a call made by a visitor within a predetermined amount of time since the call is made. This makes it possible to respond to the visitor even in a case where the resident is not aware of the visitor.

In Aspect 7 of the present invention, the output control device according to Aspect 5 or 6 may be arranged such that: the output control section changes content of the automatic answer, to be carried out by the intercom slave unit, in accordance with whether or not the visitor subjected to the face recognition by the face recognition section is pre-registered.

With the above configuration, the content of the automatic answer is changed in accordance with whether or not a visitor is an acquaintance. This makes it possible to carry out an even more appropriate response via the automatic answer.

In Aspect 8 of the present invention, the output control device in accordance with any one of Aspects 5 to 7 may be arranged such that: in a case where the face recognition carried out by the face recognition section is unsuccessful, the output control section controls the intercom slave unit so that the intercom slave unit outputs, as the automatic answer, a notification which prompts the visitor to respond in such a way that the face recognition section can carry out the face recognition successfully.

With the above configuration, in a case where the face recognition is unsuccessful, the intercom slave unit is controlled so as to output a notification which prompts the visitor to respond in such a way that the face recognition section can carry out the face recognition successfully. This makes it possible for the visitor to respond in an appropriate way such that the face recognition will succeed. This also makes it possible to eliminate visitors who are averse to face recognition (for example, salespersons or thieves).

In Aspect 9 of the present invention, the output control device in accordance with any one of Aspects 1 to 8 may be arranged such that: the output control section controls the intercom master unit so that the intercom master unit provides a notification indicating that the call operation was carried out, the notification being in accordance with the result of the face recognition.

With the above configuration, the intercom master unit is controlled so as to provide a notification indicating that the call operation was carried out, the notification being in accordance with the result of the face recognition. This makes it possible for a resident to ascertain what sort of person a visitor is before conversing with the visitor.

In Aspect 10 of the present invention, the output control device of Aspect 9 may be arranged such that: the output control section changes content of the notification, to be outputted by the intercom master unit, in accordance with a category that has been assigned to the visitor subjected to face recognition by the face recognition section.

With the above configuration, the content of the notification is changed in accordance with the category of the visitor. This makes it possible for a resident to determine how to respond before conversing with the visitor. Examples of the category of the visitor include (i) categories indicating a relationship between the visitor and the resident (friend, family, etc.), (ii) categories indicating the occupation of the visitor (postal worker, delivery worker, solicitor, etc.), and (iii) a category indicating that the visitor is a suspicious person.

An intercom slave unit in accordance with Aspect 11 of the present invention includes: a human sensing section (human sensor 22) configured to detect a person present in a vicinity of an intercom slave unit, the intercom slave unit having a function of enabling a call to and a telephonic conversation with a resident; an image capturing section (image capturing section 21) configured such that in a case where the human sensing section detects the person, the image capturing section commences capturing an image of the person; and a transmitting section (image capture control section 202) configured to transmit, to an output control device according to any one of Aspects 1 to 10, the image captured by the image capturing section.

With the above configuration, in a case where the human sensing section detects a person, an image of the person is captured and transmitted to the output control device. This makes it possible for the output control device to commence face recognition before the visitor carries out a call operation.

An intercom system (intercom system 100, intercom system 200) in accordance with Aspect 12 of the present invention is an intercom system including: an intercom slave unit (shared call unit 2) having a function of enabling a call to and a telephonic conversation with a resident; an intercom master unit (indoor monitor 3) having an answer function of enabling (i) answering a call from the intercom slave unit and (ii) carrying out a telephonic conversation between the intercom master unit and the intercom slave unit; and an output control device (server 1, server 1a) which controls output relating to a call, the call being made in accordance with a call operation inputted by a visitor into the intercom slave unit, the intercom system being configured to carry out face recognition of the visitor who inputted the call operation, based on a captured image obtained from the intercom slave unit, the intercom system being configured to carry out control so that the output is carried out, in accordance with a result of the face recognition, by at least one of (i) the intercom slave unit, (ii) the intercom master unit, and (iii) a telephonic conversation device (mobile terminal 6) which differs from the intercom master unit but has the answer function.

The above configuration brings about effects similar to those of the output control device in accordance with Aspect 1.

Each of the output control device and the intercom slave unit according to the foregoing aspects of the present invention may be realized in the form of a computer. In such a case, the present invention encompasses: a control program for each of the output control device and the intercom slave unit which program causes a computer to operate as each of the sections (software elements) of the output control device or the intercom slave unit so that the output control device or the intercom slave unit can be realized in the form of a computer; and a computer-readable recording medium storing the control program therein.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1 Server (output control device)
1a Server (output control device)
2 Shared call unit (intercom slave unit)
3 Indoor monitor (intercom master unit)
6 Mobile terminal (telephonic conversation device)
21 Image capturing section
22 Human sensor (human sensing section)
100 Intercom system
101 Output control section
101a Output control section
102 Face recognition section
200 Intercom system
202 Image capture control section (transmitting section)

1. An output control device which controls output relating to a call, the call being made in accordance with a call operation inputted by a visitor into an intercom slave unit having a function of enabling a call to and a telephonic conversation with a resident, the output control device comprising:
a face recognition section configured to carry out face recognition of the visitor based on a captured image obtained from the intercom slave unit; and
an output control section which carries out control so that the output is carried out, in accordance with a result of the face recognition carried out by the face recognition section, by at least one of (i) the intercom slave unit, (ii) an intercom master unit having an answer function of enabling answering the call and carrying out a telephonic conversation with the visitor, and (iii) a telephonic conversation device which differs from the intercom master unit but has the answer function.

2. The output control device according to claim 1, wherein:
the telephonic conversation device is a mobile terminal which has been registered in the output control device; and
the output control section controls the mobile terminal so that the mobile terminal provides a notification in accordance with the result of the face recognition, which notification indicates that the call operation was carried out.

3. The output control device according to claim 2, wherein:
the output control section controls the mobile terminal so that the mobile terminal displays, in accordance with the result of the face recognition, options for how to answer the call; and
the output control section controls the intercom slave unit so that the intercom slave unit carries out, in response to the call, whichever answer is selected by the resident from among the options.

4. The output control device according to claim 3, wherein the output control section is configured to (i) determine a priority level of each of the options in accordance with the result of the face recognition and (ii) control the mobile terminal so that the mobile terminal displays the options in accordance with the priority levels thus determined.

5. The output control device according to claim 1, wherein the output control section controls the intercom slave unit so that the intercom slave unit carries out, as an answer in response to the call, an automatic answer in accordance with the result of the face recognition.

6. The output control device according to claim 5, wherein the output control section controls the intercom slave unit so that the intercom slave unit carries out the automatic answer in a case where (i) a predetermined amount of time has elapsed since the call operation was carried out and (ii) during the predetermined amount of time, no answer was carried out with use of the intercom master unit or the telephonic conversation device by the resident in response to the call.

7. The output control device according to claim 5, wherein the output control section changes content of the automatic answer, to be carried out by the intercom slave unit, in accordance with whether or not the visitor subjected to the face recognition by the face recognition section is pre-registered.

8. The output control device according to claim 5, wherein in a case where the face recognition carried out by the face recognition section is unsuccessful, the output control section controls the intercom slave unit so that the intercom slave unit outputs, as the automatic answer, a notification which prompts the visitor to respond in such a way that the face recognition section can carry out the face recognition successfully.

9. The output control device according to claim 1, wherein the output control section controls the intercom master unit so that the intercom master unit provides a notification indicating that the call operation was carried out, the notification being in accordance with the result of the face recognition.

10. The output control device according to claim 9, wherein the output control section changes content of the notification, to be outputted by the intercom master unit, in accordance with a category that has been assigned to the visitor subjected to face recognition by the face recognition section.

11. An intercom slave unit comprising:
a human sensing section configured to detect a person present in a vicinity of an intercom slave unit, the intercom slave unit having a function of enabling a call to and a telephonic conversation with a resident;
an image capturing section configured such that in a case where the human sensing section detects the person, the image capturing section commences capturing an image of the person; and
a transmitting section configured to transmit, to an output control device recited in claim 1, the image captured by the image capturing section.

12. An intercom system comprising:
an intercom slave unit having a function of enabling a call to and a telephonic conversation with a resident;
an intercom master unit having an answer function of enabling (i) answering a call from the intercom slave unit and (ii) carrying out a telephonic conversation between the intercom master unit and the intercom slave unit; and
an output control device which controls output relating to a call, the call being made in accordance with a call operation inputted by a visitor into the intercom slave unit,
the intercom system being configured to carry out face recognition of the visitor who inputted the call operation, based on a captured image obtained from the intercom slave unit,
the intercom system being configured to carry out control so that the output is carried out, in accordance with a result of the face recognition, by at least one of (i) the intercom slave unit, (ii) the intercom master unit, and (iii) a telephonic conversation device which differs from the intercom master unit but has the answer function.
